(19) United States
(12) Patent Application Publication
(10) Pub. No.: US 2012/0129470 A1
(43) Pub. Date: May 24, 2012

(54) WIRELESS COMMUNICATION APPARATUS

(75) Inventors: Tomoya TANDAI, Kawasaki-shi (JP); Koji Akita, Yokohama-shi (JP); Takeshi Tomizawa, Yokohama-shi (JP)

(73) Assignee: KABUSHIKI KAISHA TOSHIBA, Tokyo (JP)

(21) Appl. No.: 13/221,504

(22) Filed: Aug. 30, 2011

(30) Foreign Application Priority Data
Nov. 19, 2010 (JP) 2010-259444

(51) Int. Cl. H04W 88/02

(52) U.S. Cl. 455/73

(57) ABSTRACT

According to one embodiment, a wireless communication apparatus includes a first timer, a generation unit, a transmitter, a receiver and a control unit. The first timer is configured to periodically measure a first time interval. The generation unit is configured to generate a connection request frame. The transmitter is configured to transmit the connection request frame. The receiver is configured to receive a response signal provided in response to the connection request frame. The control unit is configured to control the transmitter and the receiver in such a manner that iterative attempts are made to carry out a transmission of the connection request frame and a wait for reception of the response signal during the first time interval measured by the first timer.

### CROSS-REFERENCE TO RELATED APPLICATIONS

This application is based upon and claims the benefit of priority from prior Japanese Patent Application No. 2010-259444, filed Nov. 19, 2010, the entire contents of which are incorporated herein by reference.

### FIELD

Embodiments described herein relate generally to wireless communication.

### BACKGROUND

A wireless communication scheme is known in which one of two wireless communication apparatuses transmits a connection request signal to the other wireless communication apparatus, while the other wireless communication apparatus waits to receive the connection request signal so that a wireless connection can be established between the two wireless communication apparatuses. In a wireless communication scheme of this kind, in order to reduce power consumption, the wireless communication apparatus waiting for reception may be designed for intermittent operation instead of constant operation. The wireless communication scheme for the intermittent reception of the connection request signal disadvantageously requires a long time until the connection is established unless a timing for a transmission of the connection request signal appropriately matches a timing for a wait for reception of the connection request signal. On the other hand, a careless increase in the period of time for reception wait is not preferable in terms of power consumption.

### BRIEF DESCRIPTION OF THE DRAWINGS

FIG. 1 is a diagram illustrating a wireless communication system including a wireless communication apparatus according to each embodiment;

FIG. 2 is a block diagram illustrating a wireless communication apparatus according to a first embodiment;

FIG. 3 is a flowchart illustrating operation of the wireless communication apparatus in FIG. 2;

FIG. 4 is a timing chart illustrating the operation of the wireless communication apparatus in FIG. 2;

FIG. 5 is a block diagram illustrating a wireless communication apparatus according to a second embodiment;

FIG. 6A is a flowchart illustrating operation of the wireless communication apparatus in FIG. 5;

FIG. 6B is a flowchart illustrating the operation of the wireless communication apparatus in FIG. 5;

FIG. 7 is a timing chart illustrating the operation of the wireless communication apparatus in FIG. 5;

FIG. 8 is a block diagram illustrating a wireless communication apparatus according to a third embodiment;

FIG. 9 is a flowchart illustrating operation of the wireless communication apparatus in FIG. 8;

FIG. 10 is a timing chart illustrating the operation of the wireless communication apparatus in FIG. 8;

FIG. 11 is a block diagram illustrating a wireless communication apparatus according to a fourth embodiment;

FIG. 12 is a flowchart illustrating operation of the wireless communication apparatus in FIG. 11;

FIG. 13 is a timing chart illustrating operation of a wireless communication apparatus according to a fifth embodiment;

FIG. 14 is a block diagram illustrating a wireless communication apparatus according to a sixth embodiment;

FIG. 15 is a flowchart illustrating operation of the wireless communication apparatus in FIG. 14;

FIG. 16 is a block diagram illustrating a wireless communication apparatus according to a seventh embodiment;

FIG. 17 is a flowchart illustrating operation of the wireless communication apparatus in FIG. 16;

FIG. 18 is a block diagram illustrating a wireless communication apparatus according to an eighth embodiment;

FIG. 19 is a flowchart illustrating operation of the wireless communication apparatus in FIG. 18;

FIG. 20 is a flowchart illustrating the operation of the wireless communication apparatus in FIG. 18;

FIG. 21 is a block diagram illustrating a wireless communication apparatus according to a ninth embodiment;

FIG. 22 is a flowchart illustrating operation of the wireless communication apparatus in FIG. 21;

FIG. 23 is a flowchart illustrating operation of a wireless communication apparatus according to a tenth embodiment;

FIG. 24 is a block diagram illustrating a wireless communication apparatus according to an eleventh embodiment;

FIG. 25 is a flowchart illustrating operation of the wireless communication apparatus in FIG. 24;

FIG. 26 is a block diagram illustrating a wireless communication apparatus according to a twelfth embodiment;

FIG. 27 is a flowchart illustrating operation of the wireless communication apparatus in FIG. 26;

FIG. 28 is a flowchart illustrating operation of a wireless communication apparatus according to a thirteenth embodiment;

FIG. 29 is a flowchart illustrating operation of a wireless communication apparatus according to a fourteenth embodiment;

FIG. 30 is a diagram illustrating an interval and a subinterval measured in a wireless communication apparatus according to a fifteenth embodiment;

FIG. 31 is a block diagram illustrating a wireless communication apparatus according to a sixteenth embodiment;

FIG. 32 is a block diagram illustrating a wireless communication apparatus according to a seventeenth embodiment;

FIG. 33 is a block diagram illustrating a wireless communication apparatus according to an eighteenth embodiment;

FIG. 34 is a block diagram illustrating a wireless communication apparatus according to a nineteenth embodiment;

FIG. 35 is a block diagram illustrating a wireless communication apparatus according to a twentieth embodiment;

FIG. 36 is a block diagram illustrating a wireless communication apparatus according to a twenty-first embodiment;

FIG. 37 is a block diagram illustrating a wireless communication apparatus according to a twenty-second embodiment;

FIG. 38 is a block diagram illustrating a wireless communication apparatus according to a twenty-third embodiment;

FIG. 39 is a block diagram illustrating a wireless communication apparatus according to a twenty-fourth embodiment;

FIG. 40 is a block diagram illustrating a wireless communication apparatus according to a twenty-fifth embodiment;

FIG. 41 is a block diagram illustrating a wireless communication apparatus according to a twenty-sixth embodiment;

FIG. 42 is a block diagram illustrating a wireless communication apparatus according to a twenty-seventh embodiment;

FIG. 43A is a timing chart illustrating operation of the wireless communication apparatus in FIG. 14;

FIG. 43B is a timing chart illustrating the operation of the wireless communication apparatus in FIG. 14;

FIG. 44 is a timing chart illustrating operation of the wireless communication apparatus in FIG. 16;

FIG. 45 is a timing chart illustrating operation of the wireless communication apparatus in FIG. 18;

FIG. 46 is a timing chart illustrating the operation of the wireless communication apparatus in FIG. 18;

FIG. 47 is a timing chart illustrating operation of the wireless communication apparatus in FIG. 21;

FIG. 48 is a timing chart illustrating operation of the wireless communication apparatus according to the tenth embodiment;

FIG. 49 is a timing chart illustrating operation of the wireless communication apparatus in FIG. 24;

FIG. 50 is a timing chart illustrating operation of the wireless communication apparatus in FIG. 26;

FIG. 51 is a timing chart illustrating operation of the wireless communication apparatus according to the thirteenth embodiment; and

FIG. 52 is a timing chart illustrating operation of the wireless communication apparatus according to the fourteenth embodiment.

### DETAILED DESCRIPTION

Embodiments will be described below with reference to the drawings.

In general, according to one embodiment, a wireless communication apparatus includes a first timer, a generation unit, a transmitter, a receiver and a control unit. The first timer is configured to periodically measure a first time interval. The generation unit is configured to generate a connection request frame. The transmitter is configured to transmit the connection request frame. The receiver is configured to receive a response signal provided in response to the connection request frame. The control unit is configured to control the transmitter and the receiver in such a manner that iterative attempts are made to carry out a transmission of the connection request frame and a wait for reception of the response signal during the first time interval measured by the first timer.

In the embodiments, elements that are the same as or similar to already described elements are denoted by the same or similar reference numerals. Duplicate descriptions are basically omitted. Furthermore, in the description below, the terms “frame” and “signal” can be basically appropriately exchanged with each other.

### First Embodiment

A wireless communication system including wireless communication apparatuses 1, 2, and 3 according to a first or another embodiment will be described below with reference to FIG. 1. The wireless communication apparatuses 1, 2, and 3 are typically engaged with what is called short-distance wireless communication but may of course be involved in another type of wireless communication. The wireless communication apparatus 1, 2, and 3 carry out communication on a one-on-one basis. That is, while the wireless communication apparatuses 1 and 2 are carrying out mutual transmissions and receptions 4 of a series of frames (for example, transmissions and receptions of frames for connection and transmissions and receptions of data frames), the wireless communication apparatus 3 does not communicate with the wireless communication apparatuses 1 and 2. Thus, for example, the wireless communication apparatus 3 carries out transmissions and receptions 5 of a series of frames to and from the wireless communication apparatus 1 after the transmissions and receptions 4 of the series of frames between the wireless communication apparatuses 1 and 2 are finished.

Specifically, in the transmissions and receptions 4 and 5 of the series of frames, two wireless communication apparatuses are connected together via transmissions and receptions of a connection request frame (for example, Connection Request: C-Req) and a connection response frame (for example, Connection Accept: C-Acc). After the connection, data frames are transmitted and received between the two wireless communication apparatuses. After the transmissions and receptions of the data frames are finished, the two wireless communication apparatuses are disconnected from each other.

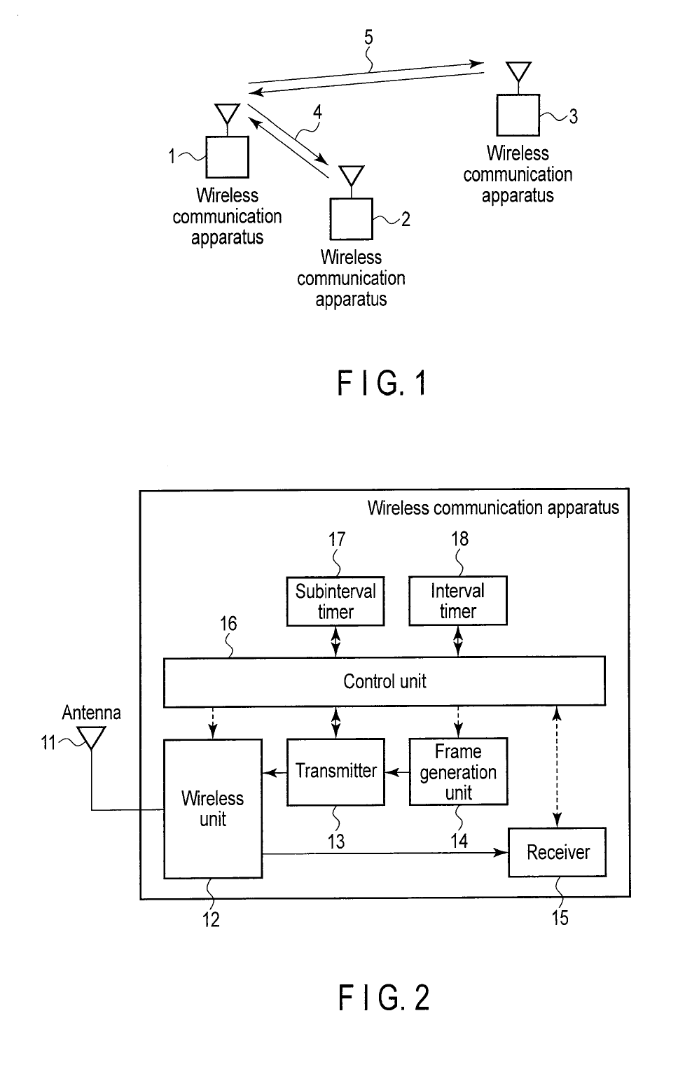

As shown in FIG. 2, the wireless communication apparatus according to the first embodiment includes a wireless unit 12, a transmitter 13, a frame generation unit 14, a receiver 15, a control unit 16, a subinterval timer 17, and an interval timer 18.

The wireless unit 12 is connected to an antenna 11. The antenna 11 is shown to be used both for a transmission process and for a reception process. However, separate antennas may be provided for the transmission process and for the reception process, respectively. The wireless unit 12 carries out one of the process for transmitting a wireless signal and the process for receiving a wireless signal in accordance with an instruction from the control unit 16. Specifically, the wireless unit 12 comprises a synthesizer, and the control unit 16 can switch between transmission and reception carried out by the synthesizer in accordance with an instruction from the control unit 16.

For example, upon receiving, from the control unit 16, an instruction to operate in a transmission mode, the wireless unit 12 carries out analog signal processing (for example, digital-analog conversion, up conversion, filtering, or power amplification) on a transmission signal from the transmitter 13. The wireless unit 12 then outputs the resultant transmission signal via the antenna 11. Furthermore, upon receiving, from the control unit 16, an instruction to operate in a reception mode, the wireless unit 12 carries out analog signal processing (for example, low-noise amplification, filtering, down conversion, or analog-digital conversion) on a reception signal from the antenna 11. The wireless unit 12 then inputs the resultant reception signal to the receiver 15. Moreover, Operation of the wireless unit 12 is controllably stopped and started by the control unit 16.

The transmitter 13 carries out various types of transmission processing (for example, digital signal processing such as modulation) on frames from the frame generation unit 14. The transmitter 13 then inputs the processed transmission signal to the wireless unit 12. Operation of the transmitter 13 is controllably stopped and started by the control unit 16.

The frame generation unit 14 generates a transmission frame (for example, a connection request frame, an ACK (ACKnowledge) frame, or a connection response frame) in accordance with an instruction from the control unit 16. The frame generation unit 14 then inputs the generated transmission frame to the transmitter 13. Furthermore, the frame generation unit 14 may add an error detection code such as a CRC parity check code to the generated frame. Operation of the frame generation unit 14 is controllably stopped and started by the control unit 16.

The receiver 15 carries out various types of reception processing (for example, digital signal processing such as demodulation) on a reception signal from the wireless unit 12. Operation of the receiver 15 is controllably stopped and started by the control unit 16.

The interval timer 18 periodically measures a predetermined time interval (hereinafter also referred to as an interval). For example, every time an interval being measured times out, the interval timer 18 starts measuring the next interval.

During the interval measured by the interval timer 18, the subinterval timer 17 measures at least one predetermined time interval (hereinafter also referred to as a subinterval) shorter than the interval. For example, the subinterval timer 17 may synchronize with the interval timer 18 and start measuring the subinterval simultaneously with the start of measurement of the interval by the interval timer 18.

The control unit 16 controls the wireless unit 12, the transmitter 13, the frame generation unit 14, and the receiver 15 during the subinterval measured by the subinterval timer 17 so that these units iterate a transmission of a connection request frame and a wait for reception of a response signal provided in response to the connection request frame.

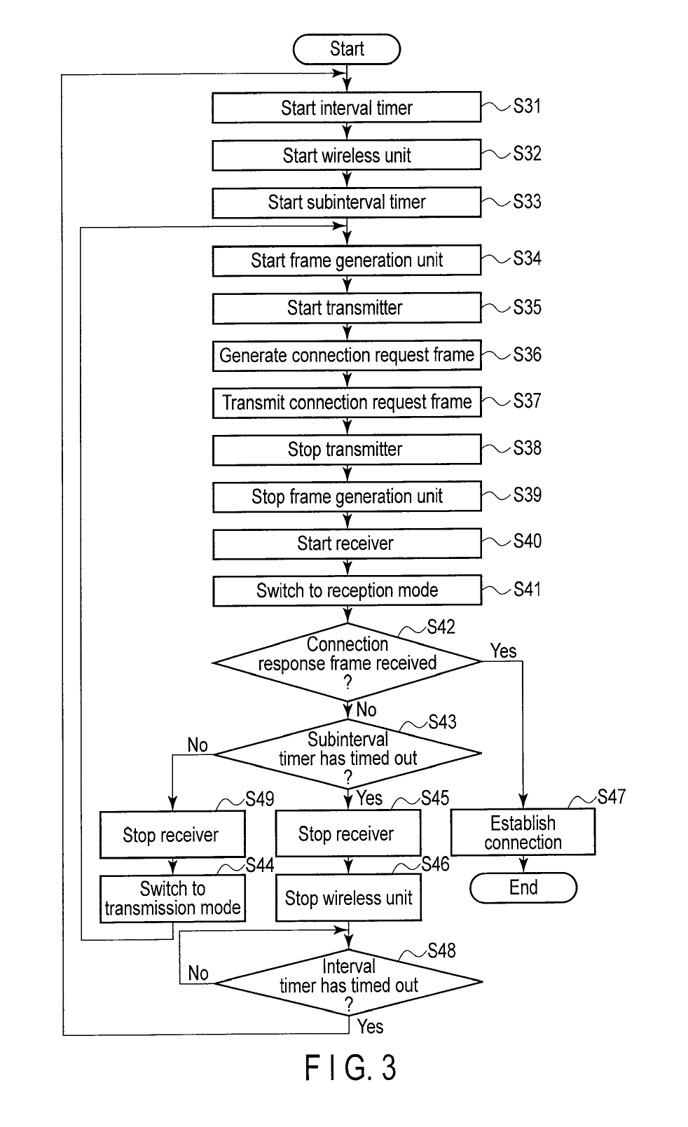

An example of operation of the wireless communication apparatus will be described below with reference to FIG. 3. The order of processing shown in FIG. 3 and other flowcharts is illustrative and may be partly changed without any problem.

After the processing illustrated in FIG. 3 is started, in step S31, the control unit 16 starts the interval timer 18 to allow the interval timer 18 to measure an interval. The control unit 16 starts the wireless unit 12 in a transmission mode (step S32). The control unit 16 starts the subinterval timer 17 to allow the subinterval timer 17 to measure a subinterval (step S33). After step S33, the control unit 16 starts the frame generation unit 14 (step S34) and then the transmitter 13 (step S35).

The frame generation unit 14, started in step S34, generates a connection request frame (step S36). The transmitter 13, started in step S35, and the wireless unit 12, started in step S32, transmit the connection request frame generated in step S36, at a predetermined timing (step S37).

After step S37, the control unit 16 stops the transmitter 13 (step S38) and thus the frame generation unit 14 (step S39). Moreover, the control unit 16 starts the receiver 15 (step S40). The control unit 16 then switches the wireless 12 unit to a reception mode (step S41). After steps S40 and S41, if a connection response frame is received, the processing proceeds to step S47. Otherwise the processing proceeds to step S43. In step S47, a connection with the peer wireless communication apparatus is established, and communication starts.

In step S43, the control unit 16 determines whether or not the subinterval timer 17, started in step S33, has timed out. If the subinterval timer 17 has timed out, the processing proceeds to step S45. Otherwise the processing proceeds to step S49. In step S45, the control unit 16 stops the receiver 15. The control unit 16 also stops the wireless unit 12 (step S46). After steps S45 and S46, the control unit 16 waits for the interval timer 18, started in step S31, to time out (step S48). Then, the processing returns to S31.

In step S49, the control unit 16 stops the receiver 15. The control unit 16 switches the wireless unit 12 to the transmission mode (step S44). After steps S49 and S44, the processing returns to step S34. That is, loop processing formed of steps S34, . . . , S41, S42, S43, S49, and S44 allows a transmission of a connection request frame and a wait for reception of a response signal provided in response to the connection request frame to be iterated.

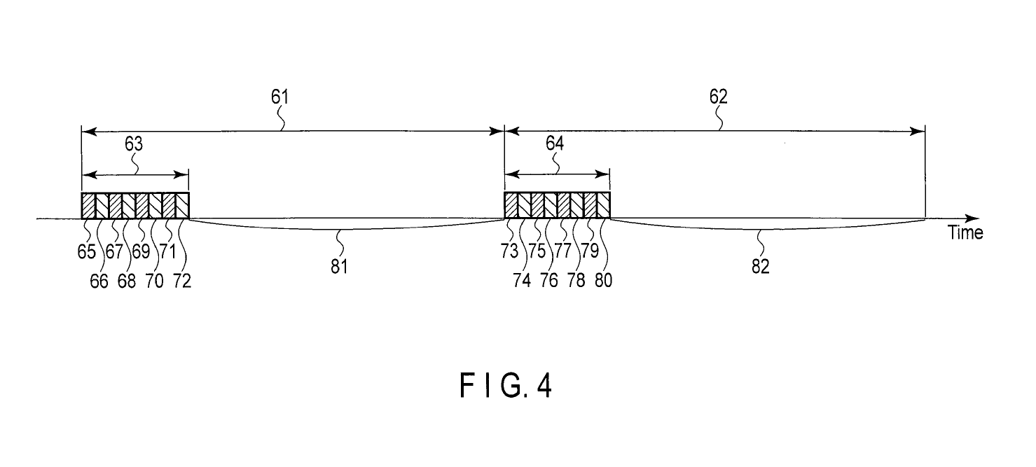

Now, an example of operation of the wireless communication apparatus in FIG. 1 will be described with reference to FIG. 4.

Two consecutive intervals 61 and 62 are shown in FIG. 4. The interval 61 contains a subinterval 63. Furthermore, the interval 62 contains a subinterval 64. A portion 81 of the interval 61 which corresponds to the entire interval 61 except for the subinterval 63, may or may not contain another subinterval (not shown in the drawings). This also applies to a portion 82 corresponding to the entire interval 62 except for the subinterval 64.

During the subinterval 63, a transmission of a connection request frame (65, 67, 69, and 71) and a wait for reception of a response signal provided in response to the connection request frame (66, 68, 70, and 72) are alternately iterated. Similarly, during the subinterval 64, a transmission of a connection request frame (73, 75, 77, and 79) and a wait for reception of a response signal provided in response to the connection request frame (74, 76, 78, and 80) are alternately iterated.

As described above, during the subinterval for intermittent transmission of connection request frames, a transmission of a connection request frame and a wait for reception of a response signal provided in response to the connection request frame are alternately iterated. Thus, according to the embodiment, even if an error in the reception of a connection request frame occurs in the peer wireless communication apparatus, further connection request frames are iteratively transmitted. Hence, a connection can be easily established in a short time.

### Second Embodiment

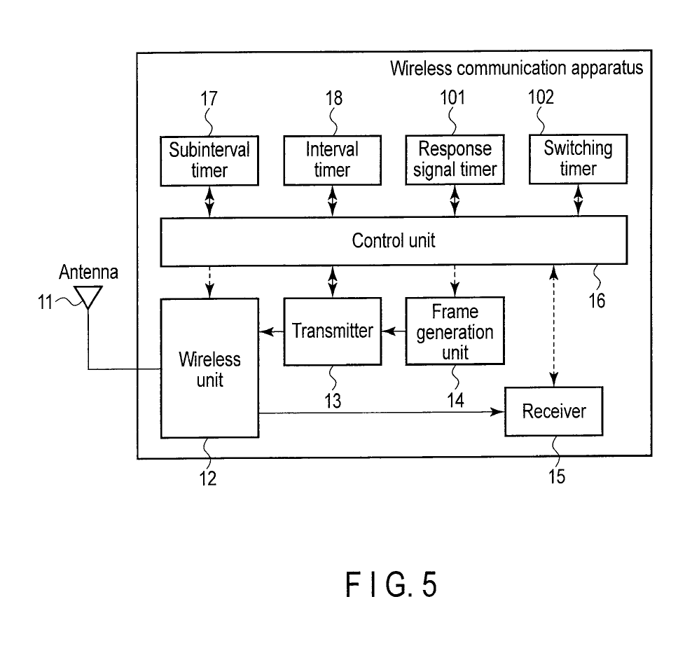

As shown in FIG. 5, a wireless communication apparatus according to a second embodiment includes a wireless unit 12, a transmitter 13, a frame generation unit 14, a receiver 15, a control unit 16, a subinterval timer 17, an interval timer 18, a response signal timer 101, and a switching timer 102.

The response signal timer 101 measures the period of time when the wireless communication apparatus waits for a response signal provided in response to an already transmitted connection request frame. The switching timer 102 measures the period of time required to switch the wireless unit 12 from the transmission mode to the reception mode after a connection request frame has been transmitted (that is, the period of time when the receiver 15 remains stopped after the connection request frame has been transmitted). For example, the switching timer 102 measures the period of time required until the synthesizer provided in the wireless unit 12 switches from the transmission mode to the reception mode. The switching timer 102 also measures the period of time required until the wireless unit is switched from the reception mode to the transmission mode after the response signal timer 101 times out (that is, the period of time when the receiver 15 remains stopped after the response signal timer 101 times out). For example, the switching timer 102 measures the period of time required until the synthesizer provided in the wireless unit 12 switches from the transmission mode to the reception mode.

The wireless communication apparatus may be designed such that the period of time required until the transmission mode is switched to the reception mode is different from the period of time required until the reception mode is switched to the transmission mode. If such a design is adopted, two switching timers 102 may be provided.

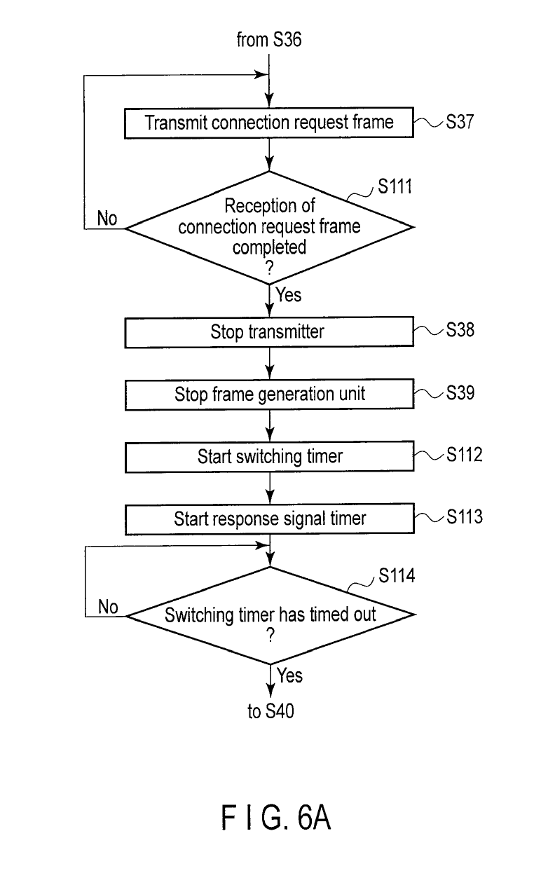

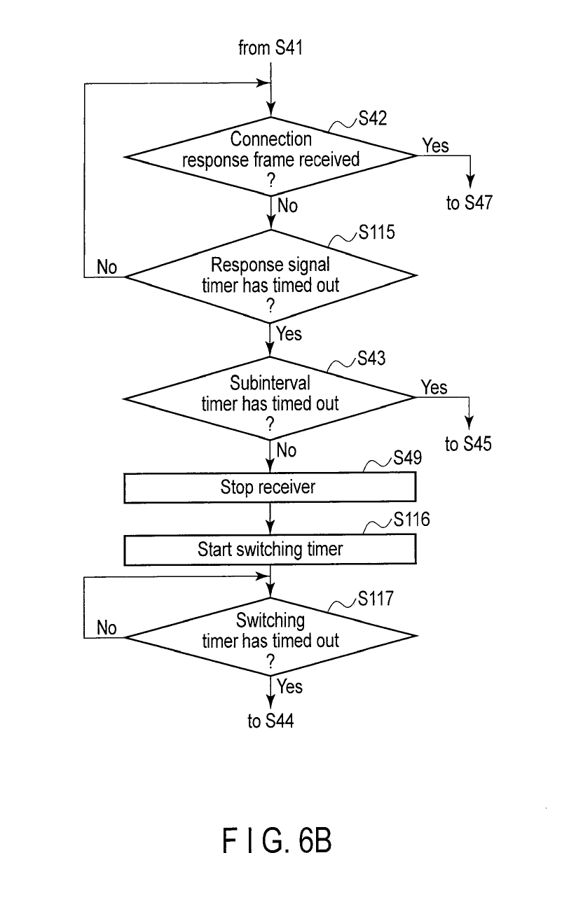

An example of operation of the wireless communication apparatus in FIG. 5 will be described below with reference to FIGS. 3, 6A, and 6B. The operation of the wireless communication apparatus in FIG. 5 partly overlaps the operation described with reference to FIG. 3. FIG. 6A and FIG. 6B illustrate differences in the operation of the wireless communication apparatus in FIG. 5 from the operation described with reference to FIG. 3.

After step S36 in FIG. 3, the processing proceeds to step S37 in FIG. 6A instead of step S37 in FIG. 3.

The control unit 16 waits for the completion of step S36, that is, the completion of transmission of a connection request frame (step S111). The processing proceeds to step S38.

After steps S38 and S39, the control unit 16 starts the switching timer 102 (step S112) and the response signal timer 101 (step S113). The control unit 16 waits until the switching timer 102, started in step S113, times out (step S114). The processing proceeds to step S40.

After step S41 in FIG. 3, the processing proceeds to step S42 in FIG. 6B instead of step S42 in FIG. 3. The control unit 16 waits for a response signal until the response signal timer 101, started in step S113 in FIG. 6A, times out (step S115). When the response signal timer 101 times out, the processing proceeds to step S43.

After step S49, the control unit 16 starts the switching timer 102 (step S116). The control unit 16 waits until the switching timer 102, started in step S116, times out (step S117). Then, the processing proceeds to step S44 in FIG. 3.

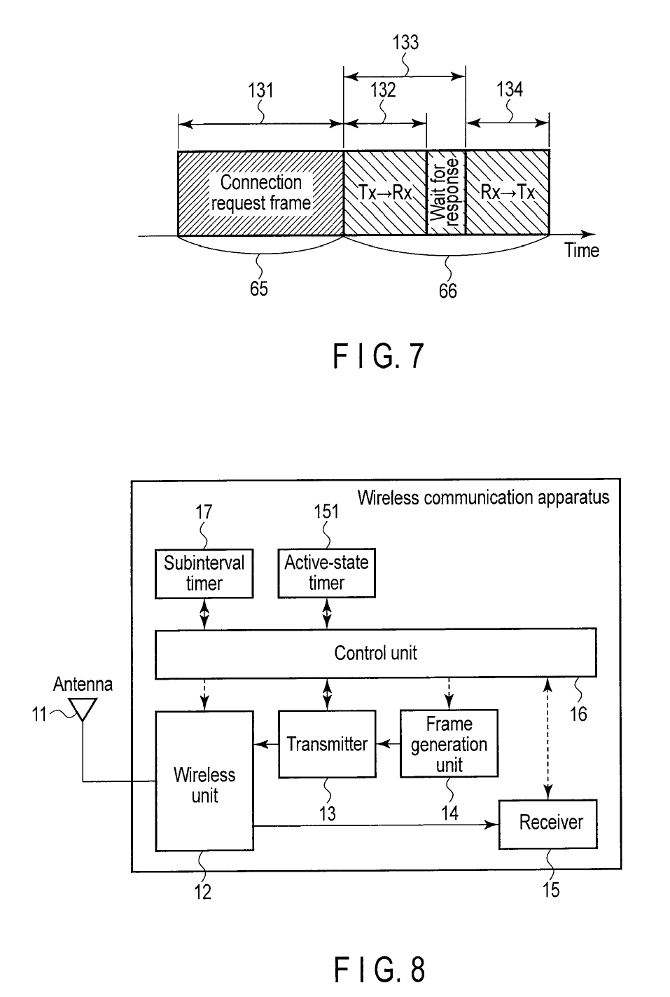

An example of operation of the wireless communication apparatus in FIG. 5 will be described below with reference to FIG. 7.

Periods of time indicated by reference numerals 65 and 66 in FIG. 7 correspond to periods of time indicated by the same reference numerals 65 and 66 in FIG. 4. That is, also in FIG. 7, the period of time 65 is intended for a transmission of a connection request frame, and the period of time 66 is intended for a wait for reception of a response signal for the connection request frame.

Specifically, after a period of time 131 (65) from the beginning to completion of transmission of a connection request frame expires, the switching timer 102 and the response signal timer 101 are started (see steps S112 and 5113 in FIG. 6A). The switching timer 102 measures the period of time 132 required until the wireless unit 12 is switched from the transmission mode to the reception mode after expiration of the period of time 131 (that is, the period of time when the receiver 15 remains stopped). On the other hand, the response signal timer 101 measures the period of time 133 when the wireless communication apparatus waits for a response signal for the connection request frame. As described above, the receiver 15 is started after the switching timer 102 times out (that is, after the period of time 132 expires). After the period of time 133 expires, the switching timer 102 is started (see step S116 in FIG. 6B). The switching timer 102 measures the period of time 134 required until the wireless unit 12 is switched from the transmission mode to the reception mode (that is, the period of time when the receiver 15 remains stopped). That is, the receiver 15 is active after the period of time 132, included in the period of time 66, expires and before the period of time 133, also included in the period of time 66, expires. However, the receiver 15 is stopped during the other periods of time 132 and 134. This sets the time for which the receiver 15 is kept active to the minimum required value.

As described above, during the subinterval, a unit period of time corresponding to a pair of the periods of time 65 and 66 is iterated a plurality of times. The unit of time includes a first period of time when the connection request frame is transmitted (for example, the period of time 131), a second period of time following the first period of time and during which the receiver 15 remains stopped (for example, the period of time 132), a third period of time following the second period of time and during which the wireless communication apparatus waits for a response signal with the receiver 15 kept active (for example, a portion of the period of time 133 which follows the expiry of the period of time 132), and a fourth period of time following the third period of time and during which the receiver 15 remains stopped (for example, the period of time 134).

As described above, the wireless communication apparatus according to the second embodiment subdivides the period of time when the wireless communication apparatus waits for a response signal according to the first embodiment. This sets the time for which the receiver is kept active to the minimum required value. Thus, the wireless communication apparatus can exert effects similar to those of the first embodiment and is expected to reduce power consumption.

### Third Embodiment

As shown in FIG. 8, a wireless communication apparatus according to the third embodiment includes a wireless unit 12, a transmitter 13, a frame generation unit 14, a receiver 15, a control unit 16, a subinterval timer 17, and an active-state timer 151.

The active-state timer 151 measures the period of time when the receiver 15 is kept active (this period of time is hereinafter also referred to as an active period). The active period is shorter than the subinterval. Specifically, the active-state timer 151 measures the active-state period at least once during the subinterval measured by the subinterval timer 17.

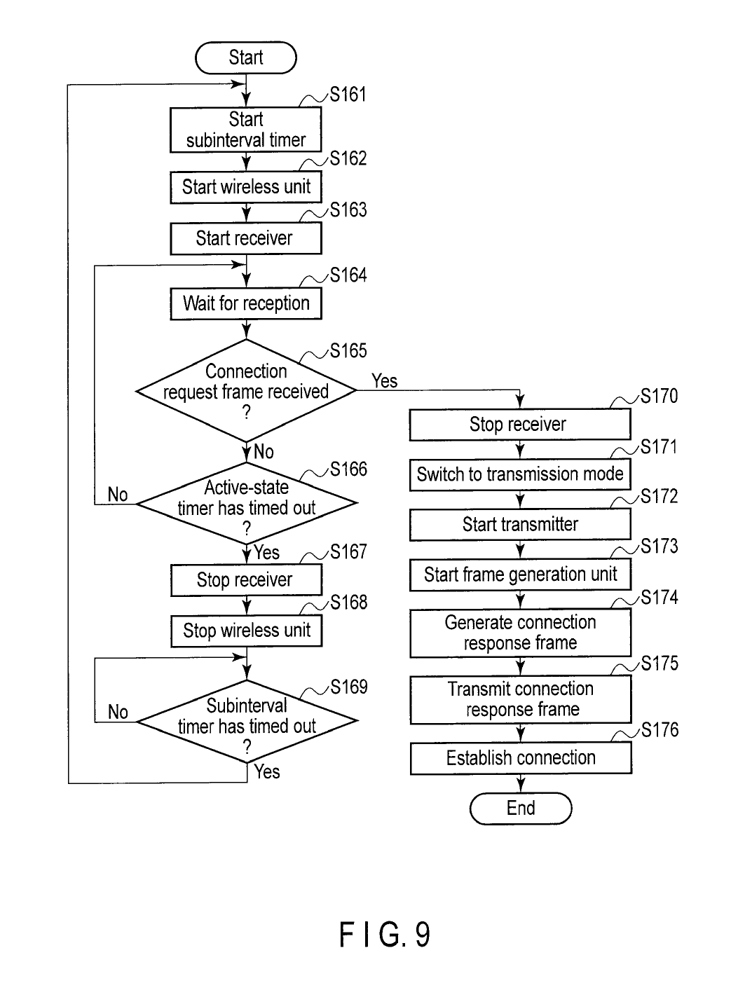

An example of operation of the wireless communication apparatus in FIG. 8 will be described below with reference to FIG. 9.

Processing in FIG. 9 is started. Then, in step S161, the control unit 16 starts the sub-interval timer 17 to allow the subinterval timer 17 to measure a subinterval. Furthermore, the control unit 16 starts the wireless unit 12 (step S162) and the receiver 15 (step S163). The control unit 16 starts the active-state timer 151 in time with step S163 to allow the active-state timer 151 to measure the active-state period, though this is not clearly shown in FIG. 9. After step S163, the processing proceeds to step S164.

In step S164, the receiver 15, started in step S163, waits to receive a signal (for example, a connection request frame). When the receiver 15 receives a connection request frame, the processing proceeds to step S170. Otherwise the processing proceeds to step S166. In step S166, the control unit 16 determines whether or not the active-state timer 151, started in time with step S163, has timed out. If the active-state timer 151 has timed out, the processing proceeds to step S167. Otherwise the processing returns to step S164. That is, during the active-state period measured by the active-state timer 151, the receiver 15 continues to wait for a connection request frame.

In step S167, the control unit 16 stops the receiver 15. The control unit 16 also stops the wireless unit 12 (step S168). After steps S167 and S168, the control unit 16 waits until the subinterval timer 17, started in step S161, times out (step S169). Then, the processing returns to step S161.

In step S170, the control unit 16 stops the receiver 15. Furthermore, the control unit 16 switches the wireless unit 12 to the transmission mode (step S171). The control unit 16 starts the transmitter 13 (step S172) and the frame generation unit 14 (step S173).

The frame generation unit 14, started in step S173, generates a connection response frame (step S174). The transmitter 13, started in step S172, and the wireless unit 12 switched to the transmission mode in step S171 transmit the connection response frame generated in step S174, at a predetermined timing (step S175). After step S175, a connection with the peer wireless communication apparatus is established (step S176). Communication is then started.

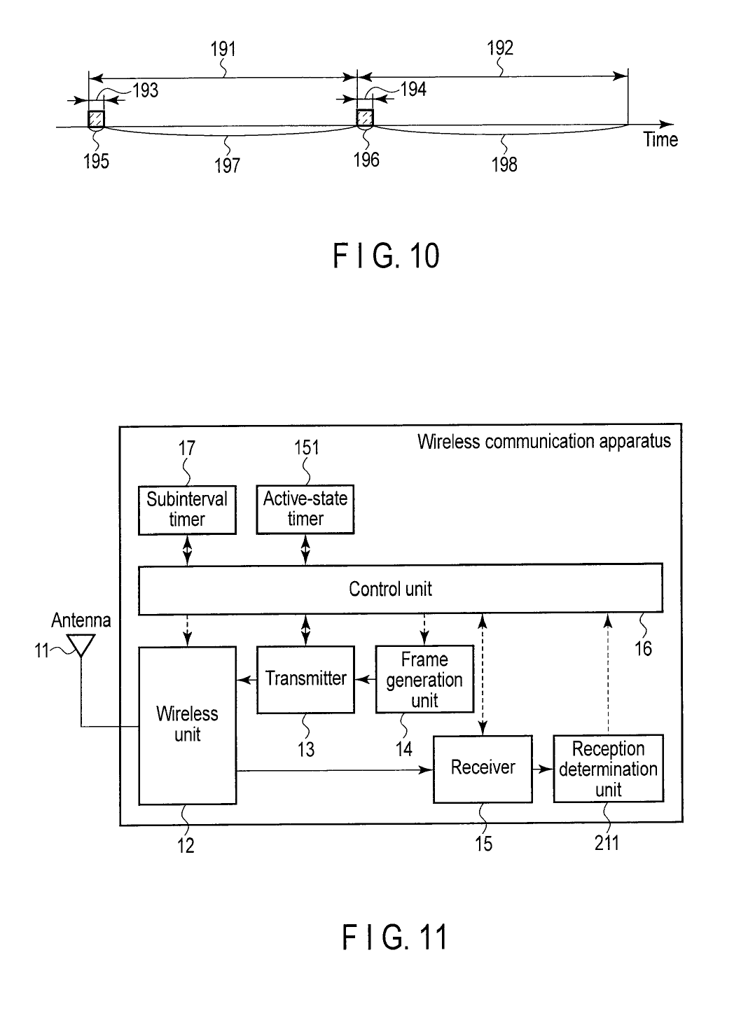

An example of operation of the wireless communication apparatus in FIG. 8 will be described below with reference to FIG. 10.

In FIG. 10, two consecutive subintervals 191 and 192 are shown. The subinterval 191 contains an active-state period 195. Furthermore, the subinterval 192 contains an active-state period 196. A portion 197 of the subinterval 191 which corresponds to the entire subinterval 191 except for the active-state period 195 (the portion following a timeout 193 of the active-state timer 151) may or may not contain another active-state period (not shown in the drawings). This also applies to a portion 198 of the subinterval 192 which corresponds to the entire subinterval 192 except for the active-state period 196 (the portion following a timeout 194 of the active-state timer 151). During a portion of each subinterval corresponding to the entire subinterval except for the active-state period, the wireless unit 12, the transmitter 13, the frame generation unit 14, the receiver 15, and the active-state timer 151 remain stopped.

As described above, the wireless communication apparatus according to the third embodiment keeps the receiver active during the active-state period contained in the subinterval for the intermittent reception of a connection request frame and measured by the active-state timer. Thus, the wireless communication apparatus sets the period of time when the receiver is kept active to the minimum required value. Hence, the wireless communication apparatus is expected to reduce power consumption.

### Fourth Embodiment

As shown in FIG. 11, a wireless communication apparatus according to the fourth embodiment includes a wireless unit 12, a transmitter 13, a frame generation unit 14, a receiver 15, a control unit 16, a subinterval timer 17, an active-state timer 151, and a reception determination unit 211.

The reception determination unit 211 determines whether or not a reception error has occurred. For example, the reception determination unit 211 determines that a reception error has occurred if an error detection code for a reception signal processed by the receiver 15 fails to be decoded.

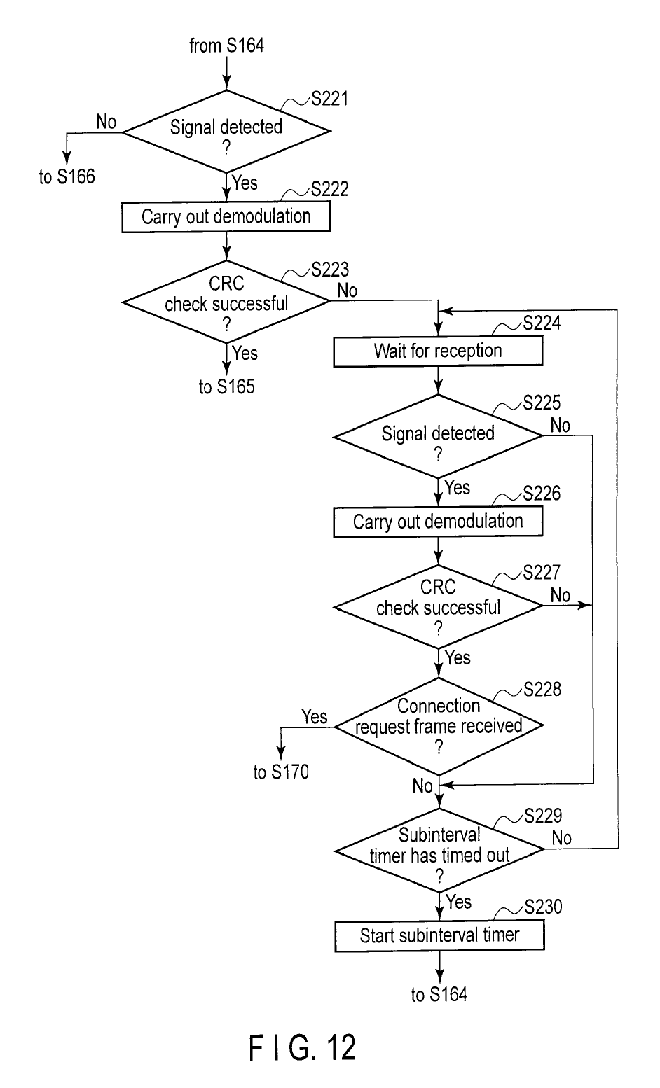

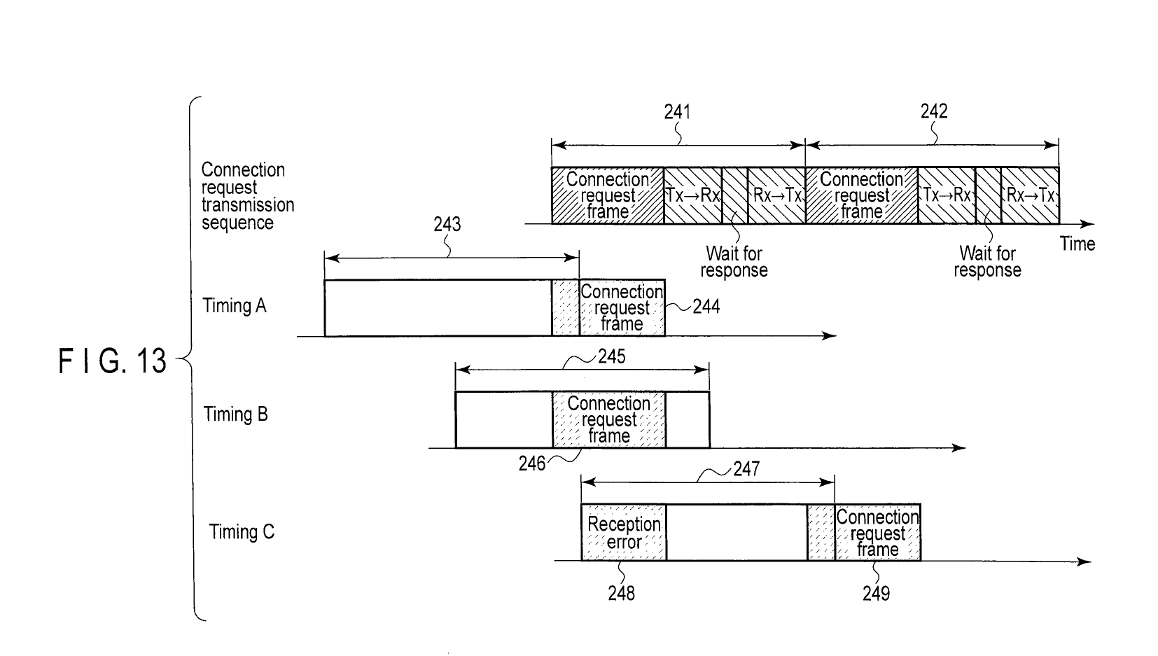

An example of operation of the wireless communication apparatus in FIG. 11 will be described below with reference to FIG. 9 and FIG. 12. The operation of the wireless communication apparatus in FIG. 11 partly overlaps the operation described with reference to FIG. 9. FIG. 12 illustrates differences in the operation of the wireless communication apparatus in FIG. 11 from the operation described with reference to FIG. 9.

After step S164 in FIG. 9, the processing proceeds to step S221 in FIG. 12 instead of step S165 in FIG. 9. In step S221, the receiver 15 determines whether or not any reception signal has been detected, for example, based on the magnitude of energy of the reception signal. If any signal has been detected, the processing proceeds to step S222. Otherwise the processing proceeds to step S166 in FIG. 9.

In step S222, the receiver 15 demodulates the reception signal. In step S223, a CRC check is carried out on the demodulated signal (of course, any other error detection code may be used). If the CRC check is successful, the processing proceeds to step S165 in FIG. 9. Otherwise the processing proceeds to step S224. That is, if the reception determination unit 211 determines a reception error, the processing proceeds to step S224. Otherwise the processing proceeds to step S165 in FIG. 9.

In step S224, the receiver 15 waits for a signal (for example, a connection request frame). In step S225, the receiver 15 determines whether or not any signal has been detected. If any signal has been detected, the processing proceeds to step S226. Otherwise the processing proceeds to step S229.

In step S226, the receiver 15 demodulates the reception signal. In step S227, a CRC check is carried out on the demodulated signal. If the CRC check is successful, the processing proceeds to step S228. Otherwise the processing proceeds to step S229. That is, if the reception determination unit 211 determines a reception error, the processing proceeds to step S229. Otherwise the processing proceeds to step S228. If a connection request frame has been received in step S228, the processing proceeds to step S170 in FIG. 9. Otherwise the processing proceeds to step S229.

In step S229, the control unit 16 determines whether or not the subinterval timer 17 has timed out. If the subinterval timer 17 has timed out, the processing proceeds to step S230. Otherwise the processing returns to step S224. In step S230, the control unit 16 starts the subinterval timer 17 to allow the subinterval timer 17 to measure a subinterval. After step S230, the processing returns to step S164.

When the processing shifts from step S223 to step S224 as described above (that is, when a reception error is determined to have occurred), the receiver 15 is kept active until the subinterval timer 18 times out, regardless of whether or not the active-state timer 151 times out.

As described above, in the wireless communication apparatus according to the fourth embodiment, when a reception error occurs during the active-state period according to the third embodiment, the receiver is kept active until the subinterval expires regardless of whether or not the active-state period expires. Thus, according to the present wireless communication apparatus, for example, if the peer wireless communication apparatus iteratively transmits a connection request frame, a connection request frame transmitted after a reception error can be received. As a result, a connected can be easily established in a short time.

### Fifth Embodiment

In the second embodiment, the unit period of time has been described in connection with the transmission of a connection request frame. On the other hand, in the third and fourth embodiments, the active-state period has been described in connection with the reception of a connection request frame. In general, an extended active-state period increases the probability of receiving a connection request frame but also increases power consumption. A wireless communication apparatus according to a fifth embodiment utilizes an active-state period of a length equal to that of the above-described unit period of time when a connection request frame is received.

Operation of the wireless communication apparatus according to the present embodiment will be described below with reference to FIG. 13.

FIG. 13 illustrates the operation performed by the wireless communication apparatus according to the present embodiment when the active-state period is set based on three different timings; A, B, and C. In FIG. 13, a connection request transmission sequence indicates operation of the peer wireless communication apparatus. The peer wireless communication apparatus performs a transmission of a connection request frame and a wait for reception of a response signal provided in response to the connection request frame during a unit period of time 241, for example, according to the second embodiment. The peer wireless communication apparatus iterates these operations during a unit period of time 242.

An active-state period 243 set in accordance with the timing A contains the leading portion of a period of time 244 when a connection request frame is transmitted. Thus, during the active-state period 243, the wireless communication apparatus can receive a connection request frame. Furthermore, an active-state period 245 set in accordance with the timing B contains the entire period of time 246 when a connection request frame is transmitted. Thus, during the active-state period 245, the wireless communication apparatus can receive the connection request frame. Moreover, an active-state period 247 set in accordance with the timing C partly overlaps a period of time 248 when a connection request frame is transmitted, but a reception error is occurring during the active-state period. However, since the active-state period 247 is equal to each of the unit periods of time 241 and 242 in length as described above, the period of time 247 contains the leading portion of a period of time 249 when the next connection request frame is transmitted. Thus, even during the active-state period 247, the wireless communication apparatus can receive the connection request frame.

As described above, the wireless communication apparatus according to the fifth embodiment utilizes the active-state period that is equal to the unit period of time in length. Thus, according to the present wireless communication apparatus, a connection request frame is likely to be received at various timings. Hence, power consumption can be suppressed, with a sufficient probability of receiving a connection request frame ensured.

### Sixth Embodiment

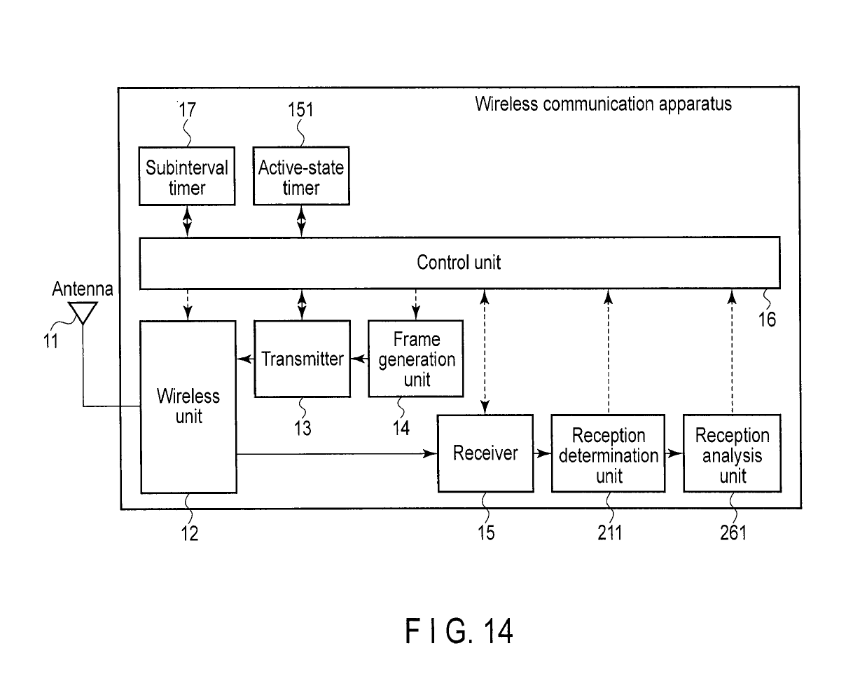

As shown in FIG. 14, a wireless communication apparatus according to a sixth embodiment includes a wireless unit 12, a transmitter 13, a frame generation unit 14, a receiver 15, a control unit 16, a subinterval timer 17, an active-state timer 151, a reception determination unit 211, and a reception analysis unit 261.

The reception analysis unit 261 analyzes the type of a signal demodulated by the receiver 15 and determined by the reception determination unit 211 to have been correctly received (that is, the signal with the error detection code successfully decoded). For example, the reception analysis unit 261 references a field indicative of the type of a reception signal and checks which of a connection request frame, an ACK frame, a connection response frame, and the like the type of the reception signal matches.

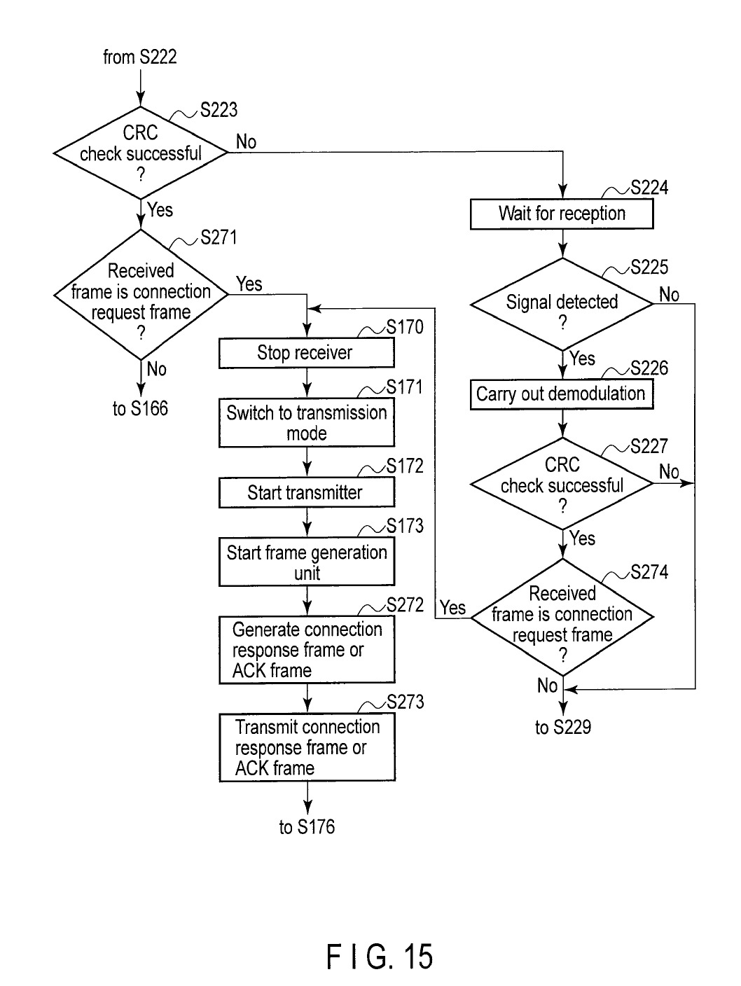

An example of operation of the wireless communication apparatus in FIG. 14 will be described below with reference to FIG. 9, FIG. 12, and FIG. 15. The operation of the wireless communication apparatus in FIG. 14 partly overlaps the operation described with reference to FIG. 9 and FIG. 12 (that is, the operation of the wireless communication apparatus in FIG. 11). FIG. 15 illustrates a portion of the operation of the wireless communication apparatus in FIG. 14 which is different from the corresponding portion of the operation illustrated in FIG. 9 and FIG. 12.

After step S222 in FIG. 12, the processing proceeds to step S223 in FIG. 15 instead of step S223 in FIG. 12. In step S223, if a CRC check is successful, the processing proceeds to step S271. Otherwise the processing proceeds to step S224.

In step S271, the reception analysis unit 261 analyzes the type of a reception signal. If the type of the reception signal matches the connection request frame, the processing proceeds to step S170. Otherwise the processing proceeds to step S166 in FIG. 9.

In step S224, the receiver 15 waits to receive a signal. In step S225, the receiver 15 determines whether or not any reception signal has been detected. If any signal has been detected, the processing proceeds to step S226. Otherwise the processing proceeds to step S229 in FIG. 12.

In step S226, the receiver 15 demodulates the reception signal. In step S227, a CRC check is carried out on the demodulated signal. If the CRC check is successful, the processing proceeds to step S274. Otherwise the processing proceeds to step S229 in FIG. 12.

In step S274, the reception analysis unit 261 analyzes the type of the reception signal. If the type of the reception signal matches the connection request frame, the processing proceeds to step S170. Otherwise the processing proceeds to step S299 in FIG. 12.

In step S170, the control unit 16 stops the receiver 15. Furthermore, the control unit 16 switches the wireless unit 12 to the transmission mode (step S171). The control unit 16 starts the transmitter 13 (step S172) and then the frame generation unit 14 (step S173).

The frame generation unit 14, started in step S173, generates a connection response frame or an ACK frame in accordance with an instruction from the control unit 16 (step S272). The transmitter 13, started in step S172, and the wireless unit 12, switched to the transmission mode in step S171, transmit the connection response frame or ACK frame generated in step S272, at a predetermined timing (step S273). After step S273, the processing proceeds to step S176 in FIG. 9.

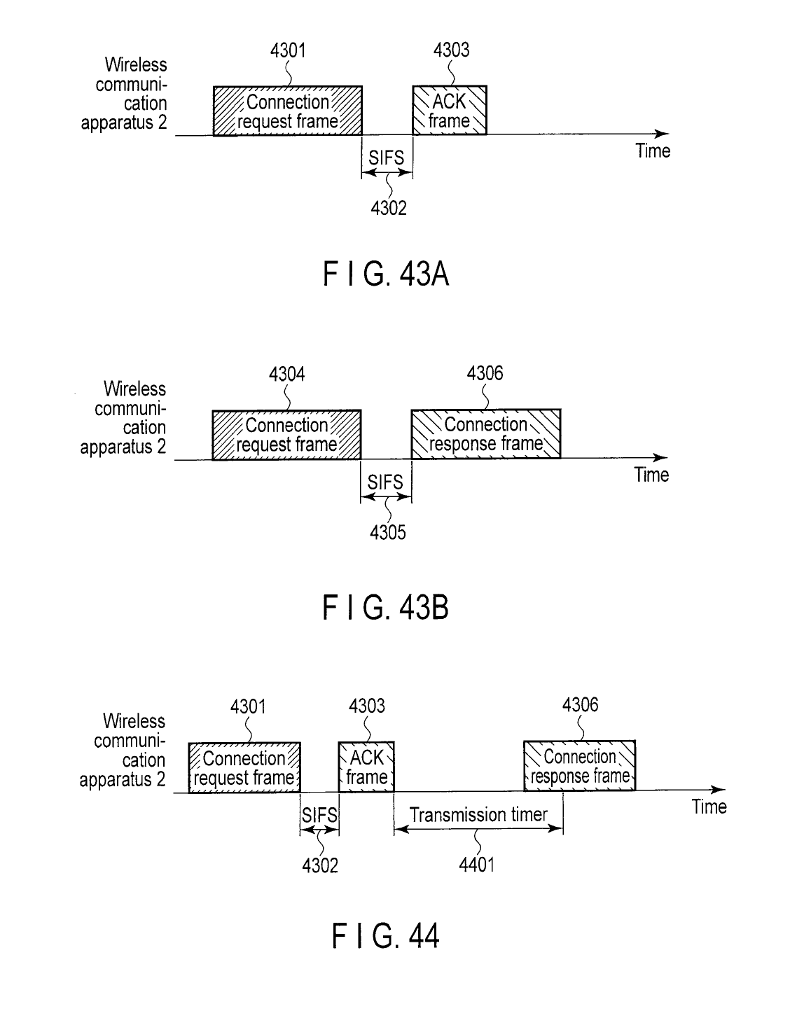

An example of operation of the wireless communication apparatus in FIG. 14 will be described below with reference to FIG. 43A and FIG. 43B.

FIG. 43A illustrates an operation performed by the wireless communication apparatus in FIG. 14 (for example, the wireless communication apparatus 2 in FIG. 1) to transmit an ACK frame 4303 after receiving a connection request frame 4301. FIG. 43A shows that the ACK frame 4303 is transmitted when a SIFS (Short Inter Frame Space) period 4302 elapses from the reception of the connection request frame 4301. The SIFS period is specified based on a wireless standard specification supported by the wireless communication apparatus according to the present embodiment.

FIG. 43B illustrates an operation performed by the wireless communication apparatus in FIG. 14 (for example, the wireless communication apparatus 2 in FIG. 1) to transmit a connection response frame 4306 after receiving a connection request frame 4304. FIG. 43B shows that the connection response frame 4306 is transmitted when a SIFS period 4305 elapses from the reception of the connection request frame 4304.

As described above, upon receiving a connection request frame, the wireless communication apparatus according to the sixth embodiment transmits a connection response frame or an ACK frame. Thus, according to the present wireless communication apparatus, even if a connection response frame cannot be transmitted for any reason, an ACK frame is transmitted instead to the peer wireless communication apparatus to enable the peer wireless communication apparatus to be notified at least of successful reception.

### Seventh Embodiment

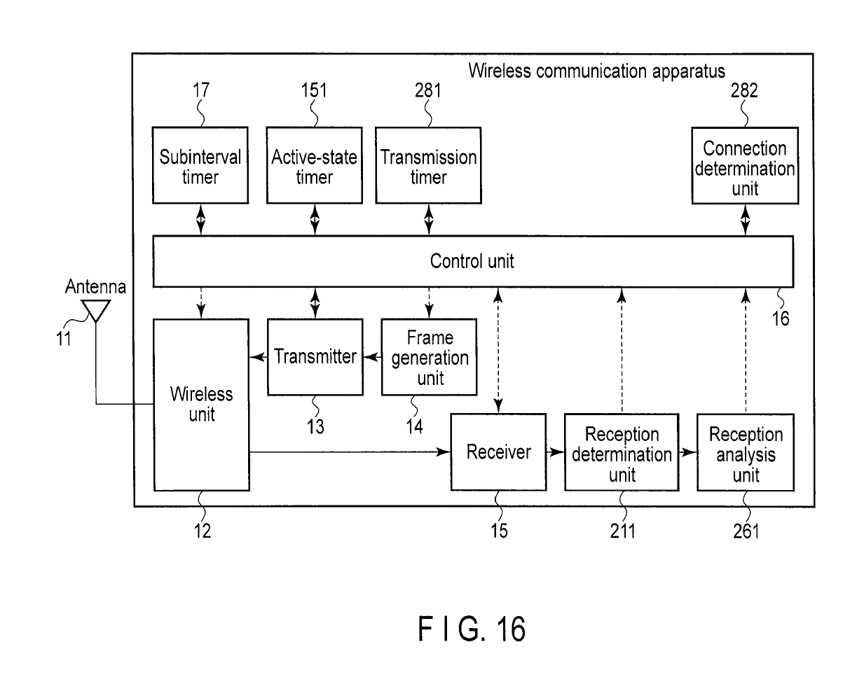

As shown in FIG. 16, a wireless communication apparatus according to a seventh embodiment includes a wireless unit 12, a transmitter 13, a frame generation unit 14, a receiver 15, a control unit 16, a subinterval timer 17, an active-state timer 151, a reception determination unit 211, a reception analysis unit 261, a transmission timer 281, and a connection determination unit 282.

The transmission timer 281 measures the maximum transmission interval between an ACK frame and a connection response frame when the wireless communication apparatus transmits the ACK frame and then the connection response frame in response to a connection request frame. That is, the wireless communication apparatus in FIG. 16, having transmitted an ACK frame, needs to transmit a connection response frame after the transmission of the ACK frame and before the transmission timer 281 times out.

When the wireless communication apparatus in FIG. 16 receives a connection request frame, the connection determination unit 282 determines whether to connect to the peer wireless communication apparatus.

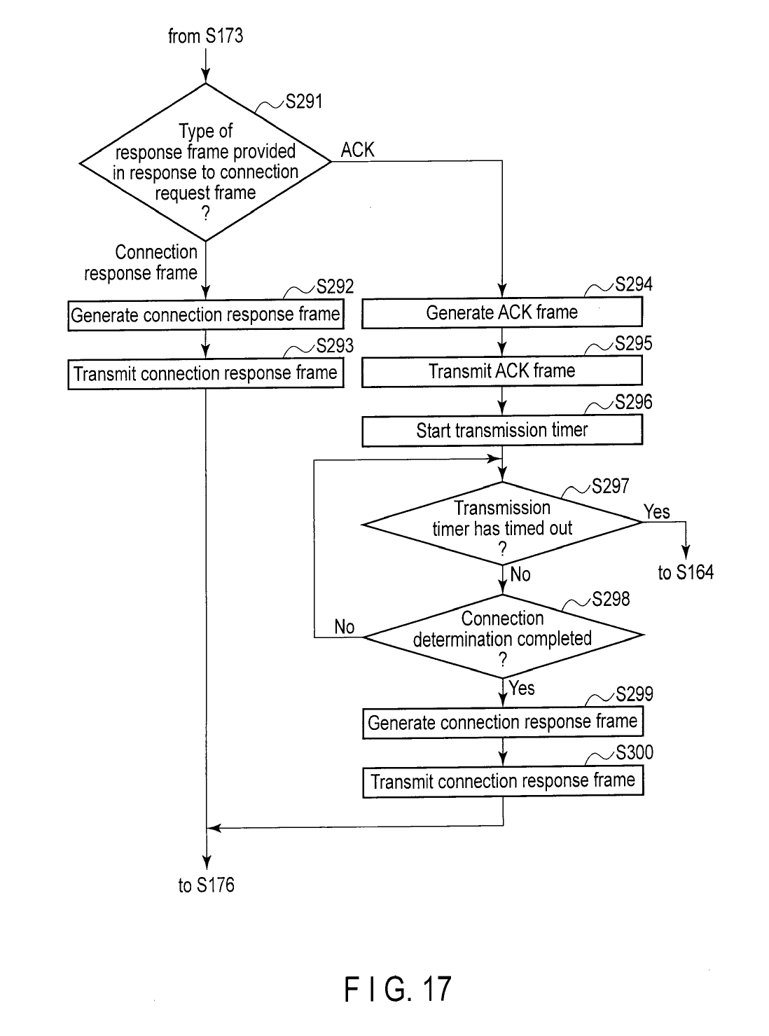

An example of operation of the wireless communication apparatus in FIG. 16 will be described below with reference to FIG. 9, FIG. 12, FIG. 15, and FIG. 17. The operation of the wireless communication apparatus in FIG. 16 partly overlaps the operation described with reference to FIG. 9, FIG. 12, and FIG. 15 (that is, the operation of the wireless communication apparatus in FIG. 14). FIG. 17 illustrates a portion of the operation of the wireless communication apparatus in FIG. 16 which is different from the corresponding portion of the operation illustrated in FIG. 9, FIG. 12, and FIG. 15.

After step S173 in FIG. 15 (or FIG. 9), the processing proceeds to step S291 in FIG. 17 instead of step S272 in FIG. 15 (or step S174 in FIG. 9). In step S291, the control unit 16 determines the type of a response frame for the received connection request frame. When the control unit 16 determines that a connection response frame is to be transmitted, the processing proceeds to step S292. On the other hand, when the control unit 16 determines that an ACK frame is to be transmitted, the processing proceeds to step S294.

In step S292, the frame generation unit 14 generates a connection response frame. The transmitter 13 and the wireless unit 12 transmit a connection response frame generated in step S292, at a predetermined timing (step S293). After step S293, the processing proceeds to step S176 in FIG. 9.

In step S294, the frame generation unit 14 generates an ACK frame. The transmitter 13 and the wireless unit 12 transmit the ACK frame generated in step S294, at a predetermined timing (step S295). The control unit 16 starts the transmission timer 281 in time with the end of step S295 (step S296).

If the connection determination unit 282 completes the connection determination before the transmission timer 281, started in step S296 times out, the processing proceeds to step S299 (steps S297 and S298). On the other hand, if the transmission timer 281 times out before the connection determination unit 282 completes the connection determination, the processing returns to step S164 in FIG. 9. Before the processing returns to step S164, the control unit 16 has stopped the transmitter 13 and the frame generation unit 14 and started the receiver 15, though this is not illustrated in FIG. 15.

In step S299, the frame generation unit 14 generates a connection response frame. The transmitter 13 and the wireless unit 12 transmit the connection response frame generated in step S299, at a predetermined timing (step S300). After step S300, the processing proceeds to step S176 in FIG. 9.

An example of operation of a wireless communication apparatus in FIG. 16 will be described below with reference to FIG. 44.

FIG. 44 illustrates an operation in which the wireless communication apparatus in FIG. 16 (for example, the wireless communication apparatus 2 in FIG. 1) transmits an ACK frame 4303 and then a connection response frame 4306, in response to a received connection request frame 4301. As illustrated in FIG. 44, as is the case with FIG. 43A, the ACK frame 4303 is transmitted when a SIFS period 4302 elapses from the reception of the connection request frame 4301. Moreover, as illustrated in FIG. 44, the connection response frame 4306 is transmitted during a period of time 4401 after the ACK frame 4303 is transmitted and before the transmission timer 281 times out.

As described above, the wireless communication apparatus according to the seventh embodiment starts the transmission timer in conjunction with the transmission of an ACK frame in response to a connection request frame. The wireless communication apparatus transmits a connection response frame before the transmission timer times out. Thus, the peer wireless communication apparatus can determine how long the apparatus needs to wait after the reception of ACK frame. Hence, a connection can be easily established in a short time by retransmission of a connection request frame or the like.

### Eighth Embodiment

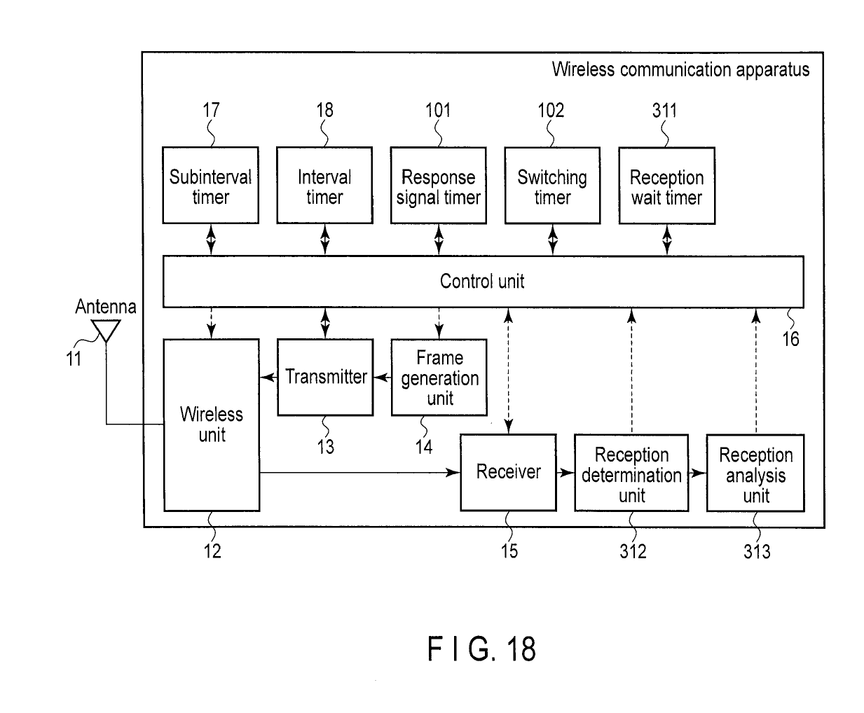

As shown in FIG. 18, a wireless communication apparatus according to an eighth embodiment includes a wireless unit 12, a transmitter 13, a frame generation unit 14, a receiver 15, a control unit 16, a subinterval timer 17, an interval timer 18, a response signal timer 101, a switching timer 102, a reception wait timer 311, a reception determination unit 312, and a reception analysis unit 313.

The reception wait timer 311 measures the maximum period of time for reception wait when the wireless communication apparatus receives an ACK frame in response to a connection request frame already transmitted by the wireless communication apparatus and waits to receive the subsequent connection response frame. That is, upon receiving the ACK frame, the wireless communication apparatus in FIG. 18 can wait to receive a connection response frame from the reception of the ACK frame until the reception wait timer 311 times out.

The reception determination unit 312 determines whether or not a reception error has occurred. For example, the reception determination unit 312 determines that a reception error has occurred if an error detection code for the reception signal processed by the receiver 15 has failed to be decoded.

The reception analysis unit 313 analyzes the type of a correctly received signal (that is, a signal on which error correction decoding has been successfully carried out). For example, the reception analysis unit 313 references the field indicative of the type of the reception signal to determine which of a connection request frame, an ACK frame, a connection response frame, and the like the type of the reception signal matches.

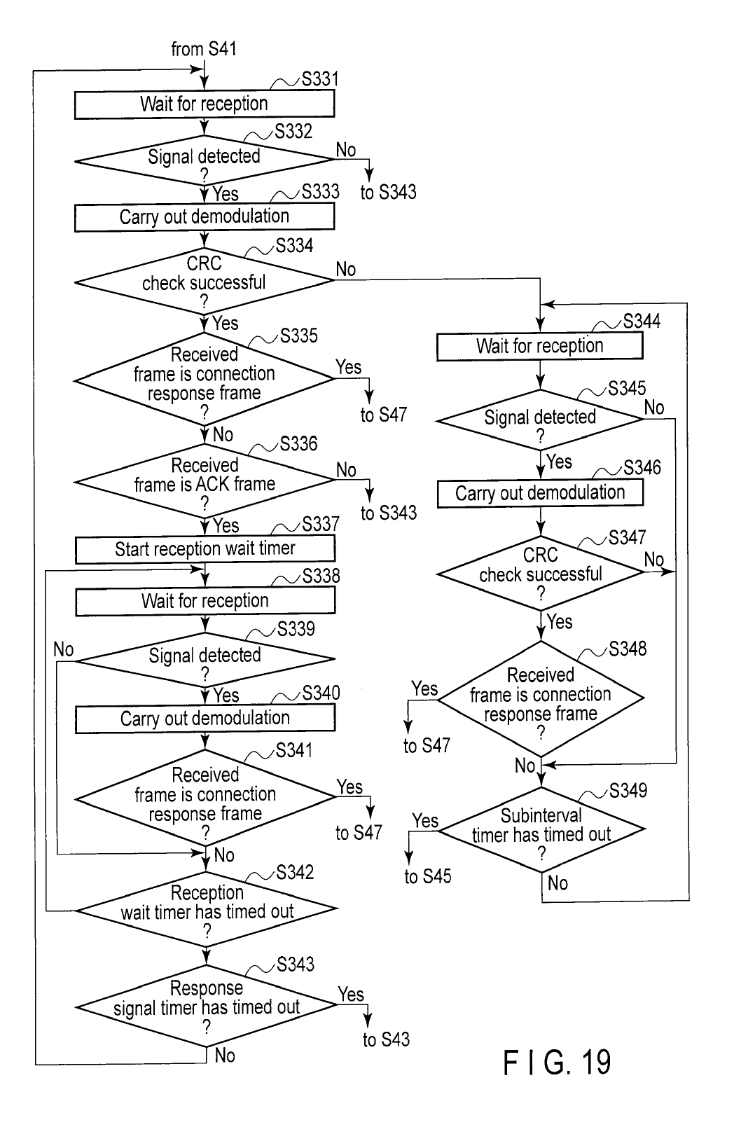

An example of operation of the wireless communication apparatus in FIG. 18 will be described below with reference to FIG. 3, FIG. 6A, FIG. 6B, and FIG. 19. The operation of the wireless communication apparatus in FIG. 18 partly overlaps the operation described with reference to FIG. 3, FIG. 6A, and FIG. 6B (that is, the operation of the wireless communication apparatus in FIG. 5). FIG. 19 illustrates differences in the operation of the wireless communication apparatus in FIG. 18 from the operation described with reference to FIG. 3, FIG. 6A, and FIG. 6B.

After step S41 in FIG. 3, the processing proceeds to step S331 in FIG. 19 instead of step S42 in FIG. 6B (or FIG. 3). In step S331, the receiver 15 waits for a signal (for example, an ACK frame or a connection response frame). In step S332, the receiver 15 determines whether or not any reception signal has been detected, for example, based on the magnitude of energy of the reception signal. If any signal has been detected, the processing proceeds to step S333. Otherwise the processing proceeds to step S343.

In step S333, the receiver 15 demodulates the reception signal. In step S334, a CRC check is carried out on the demodulated signal (of course, any other error detection code may be used). If the CRC check is successful, the processing proceeds to step S335. Otherwise the processing proceeds to step S344. That is, if the reception determination unit 312 determines a reception error, the processing proceeds to step S344. Otherwise the processing proceeds to step S335.

In steps S335 and 5336, the reception analysis unit 313 analyzes the type of the reception signal. If the type of the reception signal matches the connection response frame, the processing proceeds to step S47. If the type of the reception signal matches the ACK frame, the processing proceeds to step S337. If the type of the reception signal matches neither the connection response frame nor the ACK frame, the processing proceeds to step S343.

In step S337, the control unit 16 starts the reception wait timer 311. The processing then proceeds to step S338. In step S338, the receiver 15 waits for a signal. In step S339, the receiver 15 determines whether or not any signal has been detected. If any signal has been detected, the processing proceeds to step S340. Otherwise the processing proceeds to step S342.

In step S340, the receiver 15 demodulates the reception signal. In step S341, the reception analysis unit 313 analyzes the type of the reception signal. If the type of the reception signal matches the connection response frame, the processing proceeds to step S47 in FIG. 3. Otherwise the processing proceeds to step S342.

In step S342, the control unit 16 determines whether or not the reception wait timer 311, started in step S337, has timed out. If the reception wait timer 311 has timed out, the processing proceeds to step S343. Otherwise the processing returns to step S338.

In step S343, the control unit 16 determines whether or not the response signal timer 101, started in step S113 in FIG. 6A, has timed out. If the response signal timer 101 has timed out, the processing proceeds to step S43 in FIG. 6B. Otherwise the processing returns to step S331.

In step S344, the receiver 15 waits to receive a signal. In step S345, the receiver 15 determines whether or not any signal has been detected. If any signal has been detected, the processing proceeds to step S346. Otherwise the processing proceeds to step S349.

In step S346, the receiver 15 demodulates the reception signal. In step S347, a CRC check is carried out on the demodulated signal. If the CRC check is successful, the processing proceeds to step S348. Otherwise the processing proceeds to step S349.

In step S348, the reception analysis unit 313 analyzes the type of the reception signal. If the type of the reception signal matches the connection response frame, the processing proceeds to step S47 in FIG. 3. Otherwise the processing proceeds to step S349.

In step S349, the control unit 16 determines whether or not the subinterval timer 17, started in step S33 in FIG. 3, has timed out. If the subinterval timer 17 has timed out, the processing proceeds to step S45 in FIG. 3. Otherwise the processing returns to step S344.

As described above, once the processing shifts from step S334 to step S344 (that is, once the apparatus determines that a reception error has occurred), the receiver 15 is kept active until the subinterval timer 18 times out regardless of whether or not the response signal timer 101 and the reception wait timer 311 have timed out.

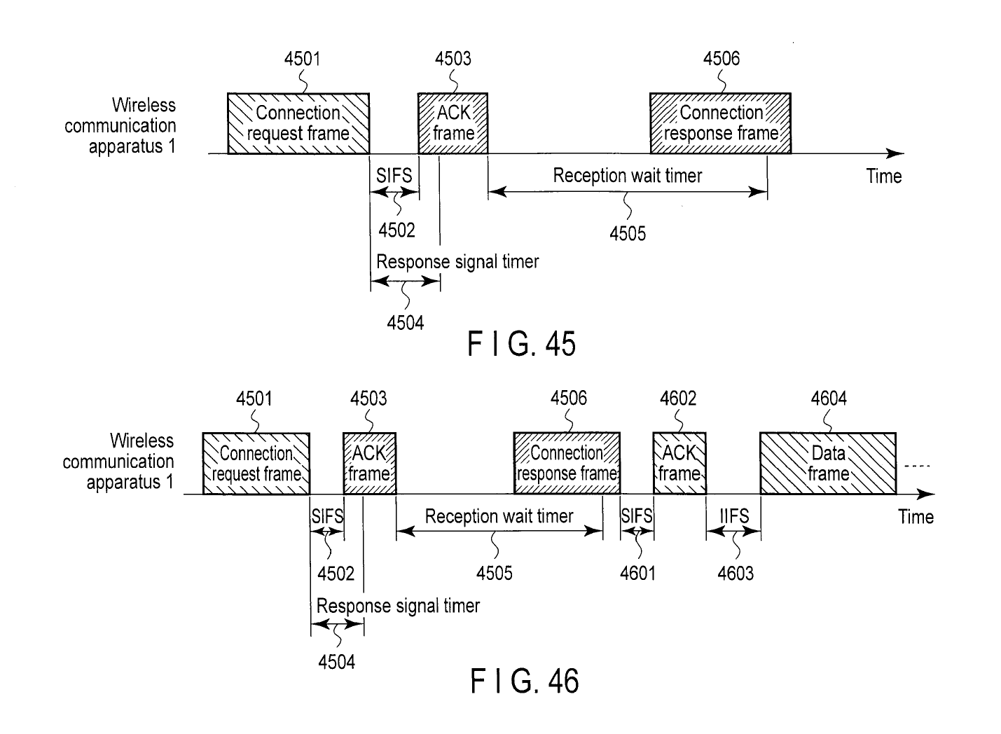

An example of operation of the wireless communication apparatus in FIG. 18 will be described below with reference to FIG. 45.

FIG. 45 illustrates an operation in which the wireless communication apparatus in FIG. 18 (for example, the wireless communication apparatus 1 in FIG. 1) receives an ACK frame 4503 and then a connection response frame 4506 which are provided in response to a connection request frame 4501 transmitted by the wireless communication apparatus in FIG. 18. FIG. 45 shows that the wireless communication apparatus receives the ACK frame when a SIFS period 4502 elapses from the transmission of the connection request frame 4501. The period of time 4504 measured by the response signal timer 101 is longer than the SIFS period 4502. Moreover, FIG. 45 shows that the wireless communication apparatus receives the connection response frame 4506 during a period of time 4505 before the timeout of the reception wait timer 311 following the reception of the ACK frame.

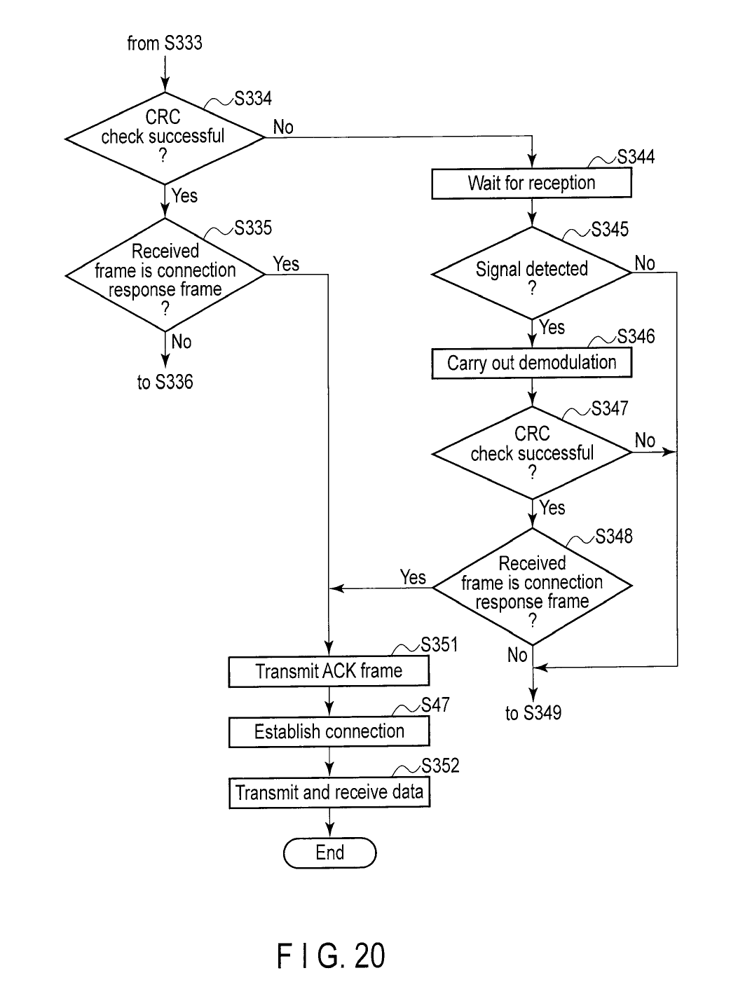

Furthermore, the operation of the wireless communication apparatus in FIG. 18 can be partly altered. The altered operation partly overlaps the operation illustrated in FIG. 3, FIG. 6A, FIG. 6B, and FIG. 19. FIG. 20 illustrates a portion of the altered operation of the wireless communication apparatus in FIG. 18 which is different from the corresponding portion of the operation illustrated in FIG. 3, FIG. 6A, FIG. 6B, and FIG. 19. Steps S334, S344, and S347 in FIG. 20 are the same as the corresponding steps in FIG. 19. Moreover, steps S335 and S348 in FIG. 20 are different from the corresponding steps in FIG. 19 in some of the steps to which steps S335 and S348 branch but are the same as the corresponding steps in FIG. 19 in the contents of processing.

In step S335 or step S348 in FIG. 20, if the type of the reception signal matches the connection response frame, the processing proceeds to step S351. In step S351, the frame generation unit 14 generates an ACK frame, and the transmitter 13 and the wireless unit 12 transmits the generated ACK frame at a predetermined timing. After step S351, a connection with the peer wireless communication apparatus is established in step S47. After step S47, the wireless communication apparatus transmits and receives data frames to and from the peer wireless communication apparatus (step S352). Thereafter, the wireless communication apparatuses are disconnected from each other. The processing then ends.

An example of altered operation of the wireless communication apparatus in FIG. 18 will be described below with reference to FIG. 46.

FIG. 46 illustrates an operation in which the wireless communication apparatus in FIG. 18 (for example, the wireless communication apparatus 1 in FIG. 1) receives the ACK frame 4503 and connection response frame 4506 provided in response to the connection request frame 4501 transmitted by the wireless communication apparatus in FIG. 18 and then transmits an ACK frame 4602 and then a data frame 4604. FIG. 46 illustrates that the ACK frame 4602 is transmitted when a SIFS period 4601 elapses from the reception of the connection response frame 4506. Moreover, FIG. 46 illustrates that the data frame 4604 is transmitted when an IIFS (Initiator Inter Frame Space) period 4603 elapses from the transmission of the ACK frame. The IIFS period is specified based on the wireless standard specification supported by the wireless communication apparatus according to the present embodiment.

As described above, the wireless communication apparatus according to the eighth embodiment involves the specified maximum period of time for waiting the reception of a connection response frame following the reception of an ACK frame provided in response to a connection request frame. Thus, the present wireless communication apparatus enables a limitation to the time for which the wireless communication apparatus waits for a connection response frame. Hence, a connection with the peer wireless communication apparatus can be easily established in a short time, with the power consumption reduced.

### Ninth Embodiment

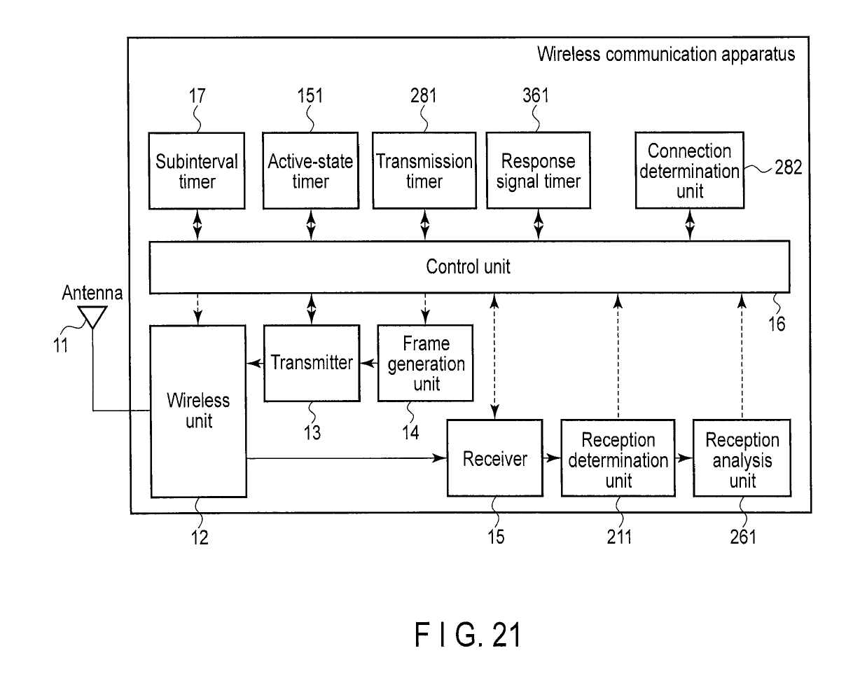

As shown in FIG. 21, a wireless communication apparatus according to a ninth embodiment includes a wireless unit 12, a transmitter 13, a frame generation unit 14, a receiver 15, a reception determination unit 211, a reception analysis unit 261, a transmission timer 281, a connection determination unit 282, and a response signal timer 361.

The response signal timer 361 measures the period of time for which the wireless communication apparatus waits for a response signal (for example, an ACK frame) provided in response to an already transmitted connection response frame.

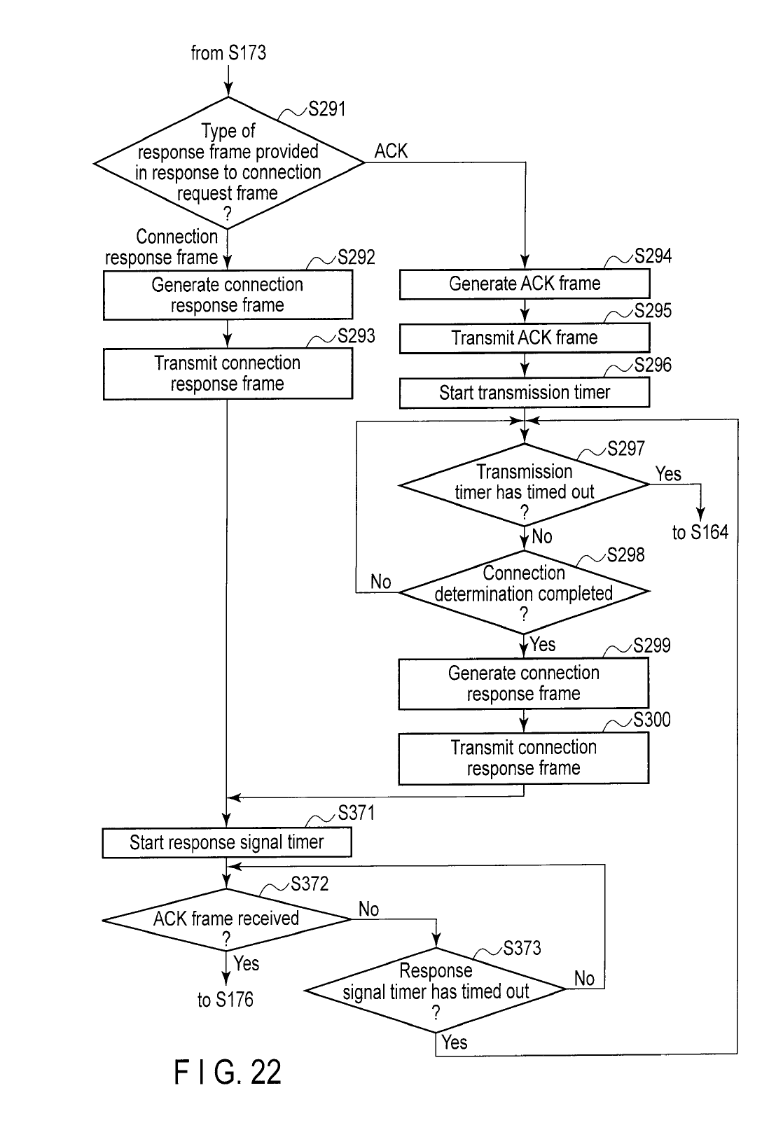

An example of operation of the wireless communication apparatus in FIG. 21 will be described below with reference to FIG. 9, FIG. 12, FIG. 15, FIG. 17, and FIG. 22. The operation of the wireless communication apparatus in FIG. 21 partly overlaps the operation illustrated in FIG. 9, FIG. 12, FIG. 15, and FIG. 17 (that is, the operation of the wireless communication apparatus in FIG. 16). FIG. 22 illustrates a portion of the operation of the wireless communication apparatus in FIG. 21 which is different from the corresponding portion of the operation illustrated in FIG. 9, FIG. 12, FIG. 15, and FIG. 17. Steps S291, 5292, 5294, . . . , and 5299 in FIG. 22 are the same as the corresponding steps in FIG. 17. Moreover, steps S293 and 5300 in FIG. 22 are different from the corresponding steps in FIG. 17 in some of the steps to which steps S293 and 5300 branch but are the same as the corresponding steps in FIG. 17 in the contents of processing.

After step S293 or step S300 in FIG. 22, the processing proceeds to step S371. In step S371, the control unit 16 starts the response signal timer 361. If an ACK frame is received before the response signal timer 361, started in step S371, times out, the processing proceeds to step S176 in FIG. 9. Otherwise the processing returns to step S297 (steps S372 and S373).

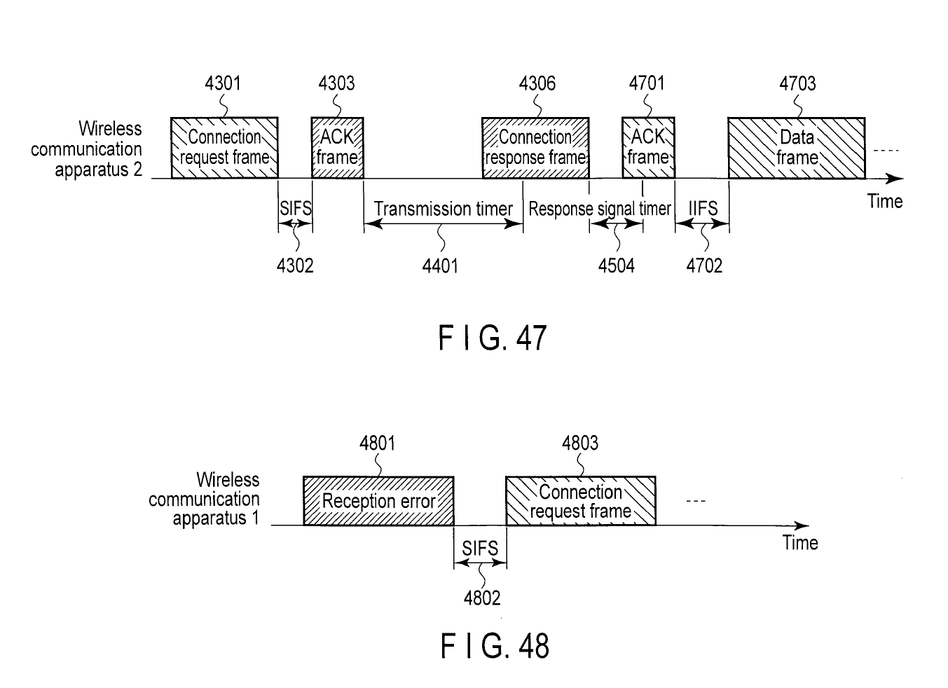

An example of operation of the wireless communication apparatus in FIG. 21 will be described below with reference to FIG. 47. FIG. 47 illustrates an operation in which the wireless communication apparatus in FIG. 21 (for example, the wireless communication apparatus 2 in FIG. 1) receives the connection request frame 4301 and transmits the ACK frame 4303 and the connection response frame 4306 as in the case of FIG. 44 and then receives an ACK frame 4701 and a data frame 4703. FIG. 47 shows that the wireless communication apparatus receives the ACK frame 4701 during a period of time 4504 after the wireless communication apparatus transmits the connection response frame and before the response signal timer 361 times out. Moreover, FIG. 47 shows that the wireless communication apparatus receives the data frame 4703 when an IIFS period 4702 elapses from the reception of the ACK frame 4701.

As described above, the wireless communication apparatus according to the ninth embodiment transmits a connection response frame, then receives an ACK frame, and thereafter transmits and receives data frames. Thus, the present wireless communication apparatus can transmit and receive data frames to and from the desired wireless communication apparatus.

### Tenth Embodiment

A wireless communication apparatus according to a tenth embodiment has the same configuration as or a configuration similar to that of the wireless communication apparatus according to the ninth embodiment.

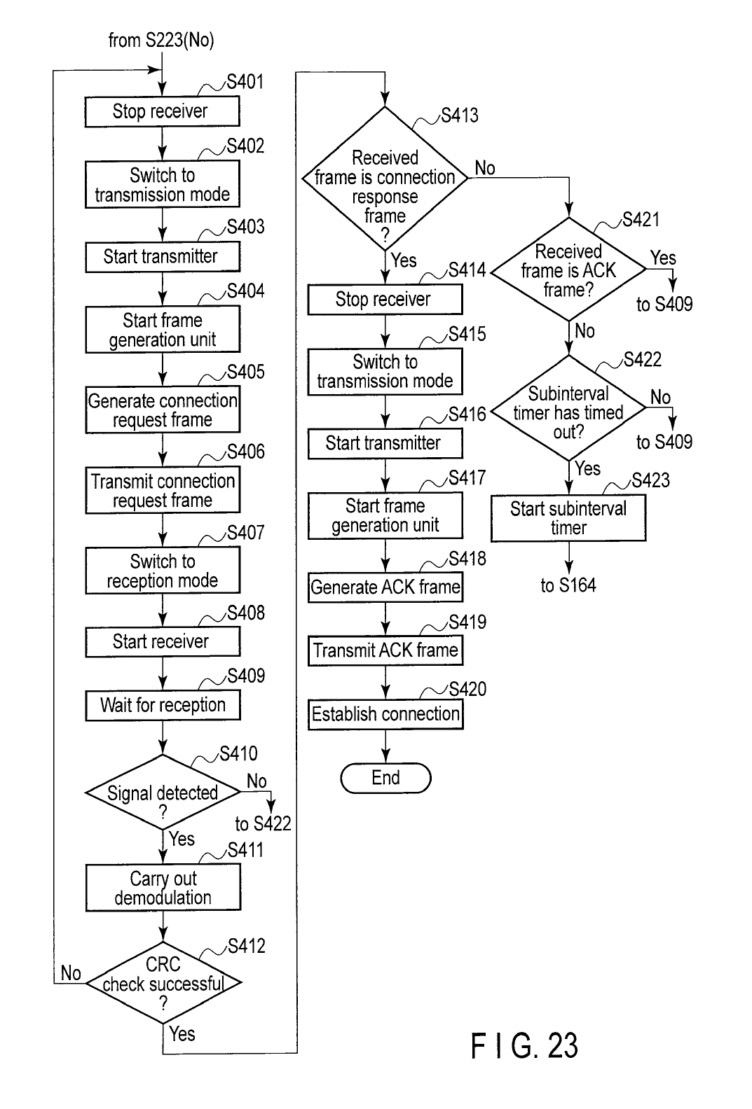

An example of operation of the wireless communication apparatus according to the present embodiment will be described below with reference to FIG. 9, FIG. 12, FIG. 15, FIG. 17, FIG. 22, and FIG. 23. The operation of the wireless communication apparatus according to the present embodiment partly overlaps the operation illustrated in FIG. 9, FIG. 12, FIG. 15, FIG. 17, and FIG. 22 (that is, the operation of the wireless communication apparatus in FIG. 21). FIG. 23 illustrates a portion of the operation of the wireless communication apparatus according to the present embodiment which is different from the corresponding portion of the operation illustrated in FIG. 9, FIG. 12, FIG. 15, FIG. 17, and FIG. 22.

In step S223 in FIG. 12 (or FIG. 15), if the CRC check fails, the processing proceeds to step S401 in FIG. 23 instead of step S224 in FIG. 12 (or FIG. 15).

In step S401, the control unit 16 stops the receiver 15. Furthermore, the control unit 16 switches the wireless unit 12 to the transmission mode (step S402). The control unit 16 starts the transmitter 13 (step S403) and the frame generation unit 14 (step S404). The frame generation unit 14, started in step S404, generates a connection request frame (step S405). The transmitter 13, started in step S403, and the wireless unit 12, switched to the transmission mode in step S402, transmit the connection request frame generated in step S405, at a predetermined timing (step S406).

That is, if a reception error occurs during a wait for a connection request frame, the wireless communication apparatus according to the present embodiment avoids waiting for the next connection request frame from the peer wireless communication apparatus. Instead, the wireless communication apparatus according to the present embodiment generates and transmits a connection request frame to the peer wireless communication apparatus.

After step S406, the control unit 16 switches the wireless unit 12 to the reception mode (step S407) and starts the receiver 15 (step S408). The receiver 15, started in step S408, waits for a signal (step S409). In step S410, the receiver 15 determines whether or not any reception signal has been detected, for example, based on the magnitude of energy of the reception signal. If any signal has been detected, the processing proceeds to step S411. Otherwise the processing proceeds to step S422.

In step S411, the receiver 15 demodulates the reception signal. In step S412, a CRC check is carried out on the demodulated signal (of course, any other error detection code may be used). If the CRC check is successful, the processing proceeds to step S413. Otherwise the processing returns to step S401.

In steps S413 and 5421, the reception analysis unit 261 analyzes the type of the reception signal. If the type of the reception signal matches the connection response frame, the processing proceeds to step S414. If the type of the reception signal matches the ACK frame, the processing proceeds to step S409. If the type of the reception signal matches neither the connection response frame nor the ACK frame, the processing proceeds to step S422.

In step S414, the control unit 16 stops the receiver 15. Furthermore, the control unit 16 switches the wireless unit 12 to the transmission mode (step S415). The control unit 16 starts the transmitter 13 (step S416) and the frame generation unit 14 (step S417). The frame generation unit 14, started in step S417, generates an ACK frame (step S418). The transmitter 13, started in step S416, and the wireless unit 12, switched to the transmission mode in step S415, transmit the ACK frame generated in step S418, at a predetermined timing (step S419). After step S420, a connection with the peer wireless communication apparatus is established.

In step S422, the control unit 16 determines whether or not the subinterval timer 17 has timed out. If the subinterval timer 17 has timed out, the processing proceeds to step S423. Otherwise the processing returns to step S409. In step S423, the control unit 16 starts the subinterval timer 17. The processing returns to step S164 in FIG. 9.

An example of operation of the wireless communication apparatus according to the present embodiment will be described below with reference to FIG. 48.

FIG. 48 illustrates an operation performed by the wireless communication apparatus according to the present embodiment (for example, the wireless communication apparatus 2 in FIG. 1) if a reception error results from a failure to correctly receive a connection request frame. FIG. 48 shows that the wireless communication apparatus transmits a connection request frame 4803 when a SIFS period 4802 elapses from the occurrence of a reception error 4801.

As described above, when an error occurs in reception of a connection request frame, the wireless communication apparatus according to the tenth embodiment generates and transmits a connection request frame. Thus, the present wireless communication apparatus increases the frequency with which the wireless communication apparatus transmits and receives connection request frames to and from the peer wireless communication apparatus. That is, the present wireless communication apparatus allows a connection to be easily established in a short time.

### Eleventh Embodiment

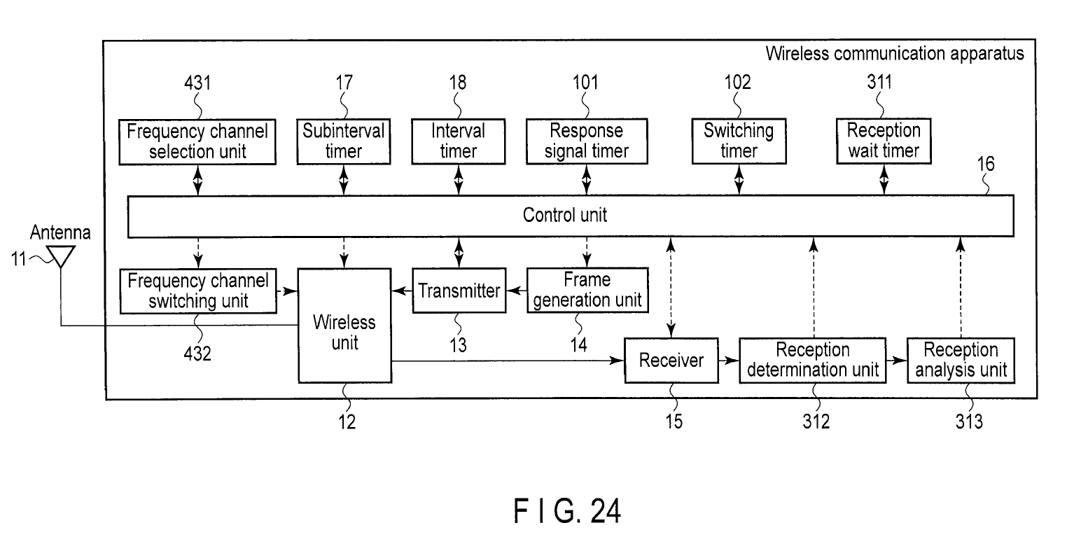

As shown in FIG. 24, a wireless communication apparatus according to an eleventh embodiment includes a wireless unit 12, a transmitter 13, a frame generation unit 14, a receiver 15, a response signal timer 101, a switching timer 102, a reception wait timer 311, reception determination unit 312, a reception analysis unit 313, a frequency channel selection unit 431, and a frequency channel switching unit 432.

The frequency channel selection unit 431 selects one of a plurality of frequency channels that can be used by the wireless communication apparatus. The frequency channel switching unit 432 switches the channel used by the wireless unit 12, the transmitter 13, and the receiver 15 to one of the plurality of frequency channels.

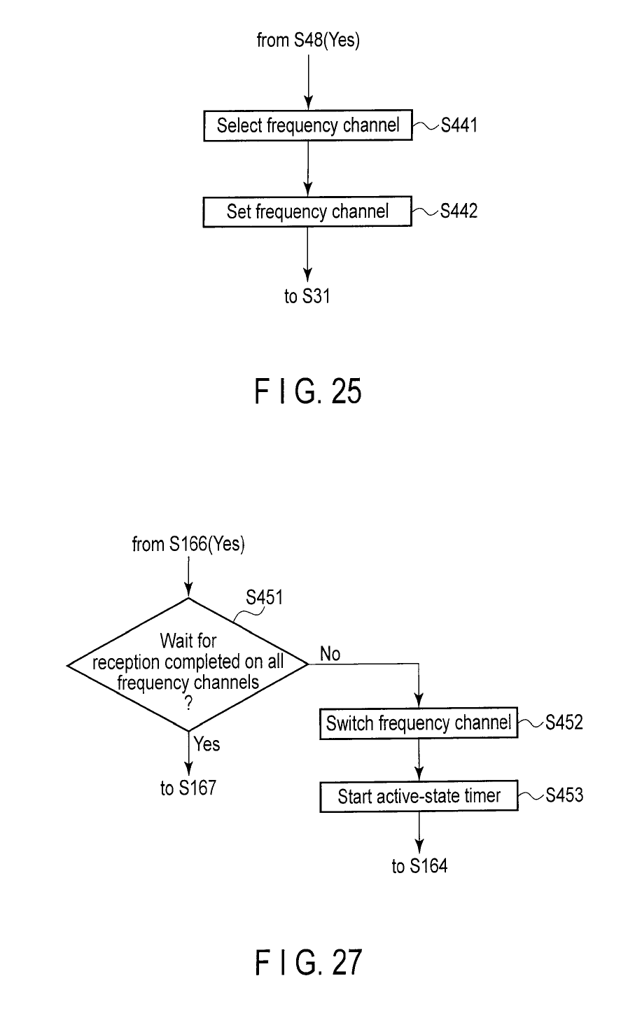

An example of operation of the wireless communication apparatus in FIG. 24 will be described below with reference to FIG. 3, FIG. 6A, FIG. 6B, FIG. 19, and FIG. 25. The operation of the wireless communication apparatus in FIG. 24 partly overlaps the operation illustrated in FIG. 3, FIG. 6A, FIG. 6B, and FIG. 19 (that is, the operation of the wireless communication apparatus in FIG. 18). FIG. 25 illustrates a portion of the operation of the wireless communication apparatus in FIG. 24 which is different from the corresponding portion of the operation illustrated in FIG. 3, FIG. 6A, FIG. 6B, and FIG. 20.

In step S48 in FIG. 3, if the interval timer 18 has timed out, the processing proceeds to step S441 in FIG. 25 instead of step S31 in FIG. 3. In step S441, the frequency channel selection unit 431 selects one of the plurality of frequency channels that can be used by the wireless communication apparatus. The frequency channel switching unit 432 switches the channel used by the wireless unit 12, the transmitter 13, and the receiver 15 to the one selected in step S441 (step S442). After step S442, the processing proceeds to step S31 in FIG. 3.

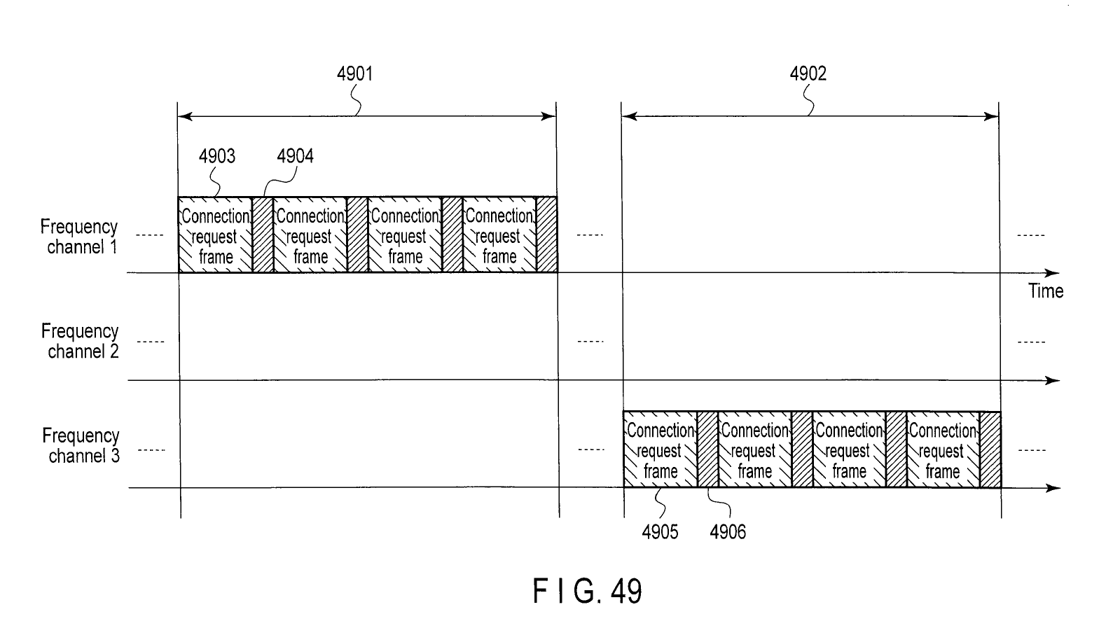

An example of operation of the wireless communication apparatus in FIG. 24 will be described below with reference to FIG. 49.

FIG. 49 illustrates an operation in which the wireless communication apparatus in FIG. 24 switches among the plurality of frequency channels. As shown in FIG. 49, during a certain subinterval 4901, the wireless communication apparatus uses a frequency channel 1 to iterate a transmission of a connection request frame (for example, 4903) and a wait for reception of a response signal provided in response to the connection request frame (for example, 4904). Moreover, as shown in FIG. 49, during another subinterval 4902, the wireless communication apparatus uses a frequency channel 3 to iterate a transmission of a connection request frame (for example, 4905) and a wait for reception of a response signal provided in response to the connection request frame (for example, 4906).

As described above, the wireless communication apparatus according to the eleventh embodiment switches the frequency channel at every subinterval and alternately iterates, during the subinterval, a transmission of a connection request frame and a wait for reception of a response signal provided in response to the connection request frame. Thus, according to the present wireless communication apparatus, even if the peer wireless communication apparatus can use a plurality of frequency channels, a connection can be easily established in a short time.

### Twelfth Embodiment

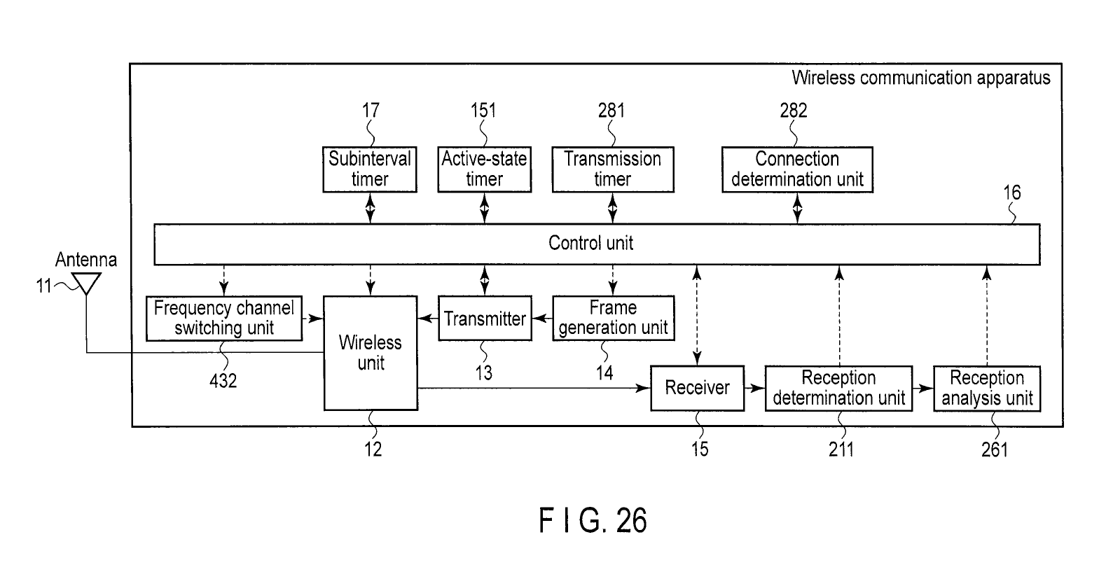

As shown in FIG. 26, a wireless communication apparatus according to a twelfth embodiment includes a wireless unit 12, a transmitter 13, a frame generation unit 14, a receiver 15, an active-state timer 151, a reception determination unit 211, a reception analysis unit 261, a transmission timer 281, a connection determination unit 282, and a frequency channel switching unit 432.

An example of operation of the wireless communication apparatus in FIG. 26 will be described below with reference to FIG. 9, FIG. 12, FIG. 15, FIG. 17, and FIG. 27. The operation of the wireless communication apparatus in FIG. 26 partly overlaps the operation illustrated in FIG. 9, FIG. 12, FIG. 15, and FIG. 17 (that is, the operation of the wireless communication apparatus in FIG. 16). FIG. 27 illustrates a portion of the operation of the wireless communication apparatus in FIG. 26 which is different from the corresponding portion of the operation illustrated in FIG. 9, FIG. 12, FIG. 15, and FIG. 17.

In step S166 in FIG. 9, if the active-state timer 151 has timed out, the processing proceeds to step S451 in FIG. 27 instead of step S167 in FIG. 9. In step S451, the apparatus determines whether or not the wait for reception has been carried out, within the current subinterval, on all the frequency channels that can be used by the wireless communication apparatus. If the wait for reception has been carried out on all the frequency channels within the current subinterval, the processing proceeds to step S167 in FIG. 9. Otherwise the processing proceeds to step S452.

In step S452, the frequency channel switching unit 432 switches the channel used by the wireless unit 12, the transmitter 13, and the receiver 15 to one of the channels on which the wait for reception has not been carried out within the current subinterval. After step S452, the control unit 16 allows the active-state timer 151 to start measuring an active-state period (step S453). The processing returns to step S164 in FIG. 9.

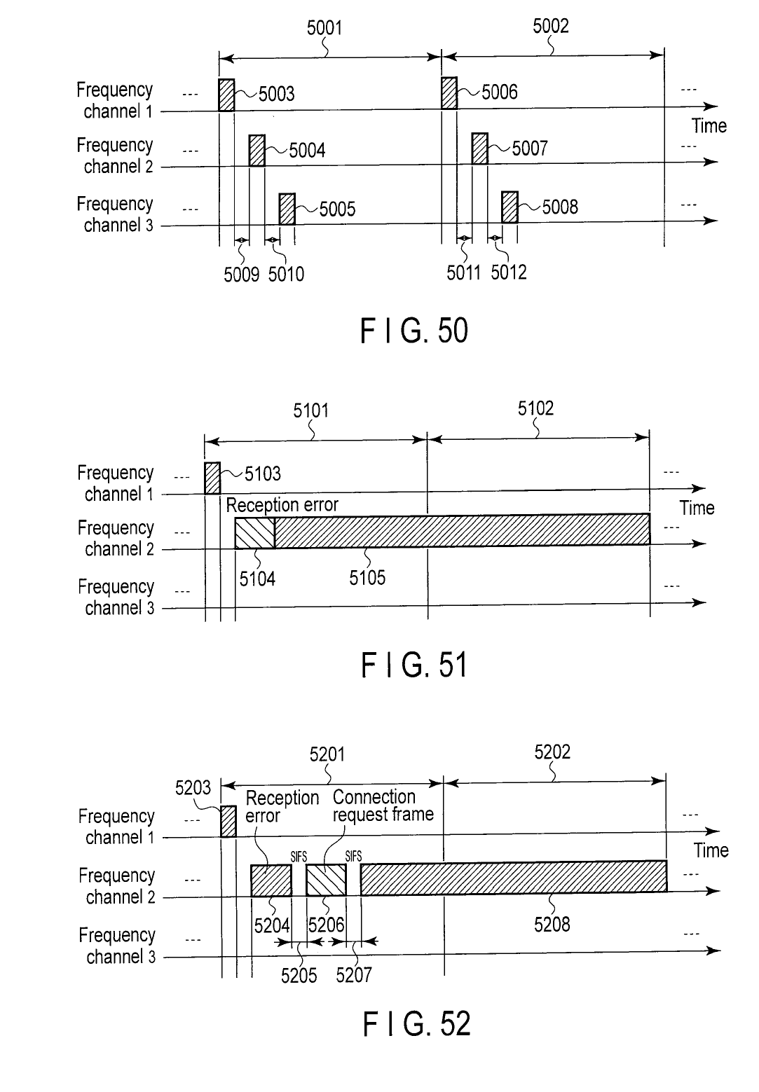

An example of operation of the wireless communication apparatus in FIG. 26 will be described below with reference to FIG. 50.

FIG. 50 illustrates an operation in which the wireless communication apparatus in FIG. 26 switches among a plurality of frequency channels within a subinterval. As shown in FIG. 50, during a subinterval 5001, the wireless communication apparatus uses the frequency channel 1 to wait for reception during an active-state period 5003, and after a delay 5009 resulting from switching of the frequency channel, uses a frequency channel 2 to wait for reception during an active-state period 5004, and after a delay 5010 resulting from switching of the frequency channel, uses a frequency channel 3 to wait for reception during an active-state period 5005. Moreover, as shown in FIG. 50, during another subinterval 5002, the wireless communication apparatus uses the frequency channel 1 to wait for reception during an active-state period 5006, and after a delay 5011 resulting from switching of the frequency channel, uses the frequency channel 2 to wait for reception during an active-state period 5007, and after a delay 5012 resulting from switching of the frequency channel, uses the frequency channel 3 to wait for reception during an active-state period 5008.

As described above, the wireless communication apparatus according to the twelfth embodiment switches among a plurality of frequency channels within the subinterval to wait to receive a connection request frame on the selected frequency channel. Thus, according to the present wireless communication apparatus, even if the peer wireless communication apparatus can use a plurality of frequency channels, a connection can be easily established in a short time.

### Thirteenth Embodiment

A wireless communication apparatus according to a thirteenth embodiment has the same configuration as or a configuration similar to that of the wireless communication apparatus according to the twelfth embodiment.

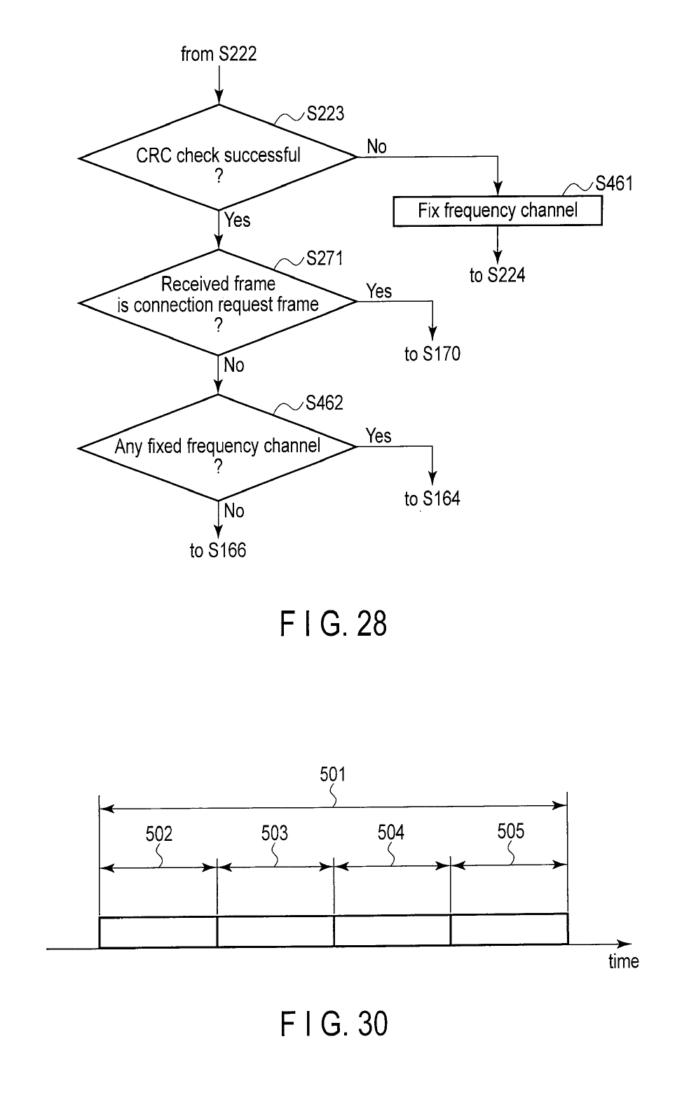

An example of operation of the wireless communication apparatus according to the present embodiment will be described below with reference to FIG. 9, FIG. 12, FIG. 15, FIG. 17, FIG. 27, and FIG. 28. The operation of the wireless communication apparatus according to the present embodiment partly overlaps the operation illustrated in FIG. 9, FIG. 12, FIG. 15, FIG. 17, and FIG. 27 (that is, the operation of the wireless communication apparatus in FIG. 26). FIG. 28 illustrates a portion of the operation of the wireless communication apparatus according to the present embodiment which is different from the corresponding portion of the operation illustrated in FIG. 9, FIG. 12, FIG. 15, FIG. 17, and FIG. 27. Steps S223 and S271 in FIG. 28 are different from the corresponding steps in FIG. 15 in some of the steps to which steps S223 and S271 branch but are the same as the corresponding steps in FIG. 15 in the contents of processing.

In step S223, if the CRC check is successful, the processing proceeds to step S271. Otherwise the processing proceeds to step S461. In step S271, if the type of the reception signal matches the connection request frame, the processing proceeds to step S170 in FIG. 15 (or FIG. 9). Otherwise the processing proceeds to step S462.

In step S461, the frequency channel switching unit 432 fixes the channel used by the wireless unit 12, the transmitter 13, and the receiver 15 to the current frequency channel (that is, the frequency channel on which a reception error has occurred). After step S461, the processing proceeds to step S224 in FIG. 15 (or FIG. 12).

In step S462, if the channel used by the wireless unit 12, the transmitter 13, and the receiver 15 is fixed to the current frequency channel, the processing returns to step S164 in FIG. 9. Otherwise the processing returns to step S166 in FIG. 9.

An example of operation of the wireless communication apparatus according to the present embodiment will be described below with reference to FIG. 51.

FIG. 51 illustrates an operation performed by the wireless communication apparatus according to the present embodiment if a reception error occurs while the wireless communication apparatus is waiting for reception using the frequency channel 2. As shown in FIG. 51, during a subinterval 5101, the wireless communication apparatus uses the frequency channel 1 to wait for reception during an active-state period 5103, and after switching of the frequency channel, uses the frequency channel 2 to wait for reception during an active-state period 5104. If a reception error occurs during the active-state period 5104, the channel used by the wireless unit 12, the transmitter 13, and the receiver 15 is fixed to the frequency channel 2. During the subsequent period 5105, the wireless communication apparatus uses the fixed frequency channel 2 to wait for reception.

As described above, if a reception error occurs, the wireless communication apparatus according to the thirteenth embodiment fixes the operating channel to wait for reception. Thus, according to the present wireless communication apparatus, if for example, the peer wireless communication apparatus iteratively transmits a connection request frame on the same frequency channel, a connection request frame transmitted after the occurrence of the reception error can be received. Hence, a connection can be easily established in a short time.

### Fourteenth Embodiment

A wireless communication apparatus according to a fourteenth embodiment has the same configuration as or a configuration similar to that of the wireless communication apparatuses according to the twelfth and thirteenth embodiments.

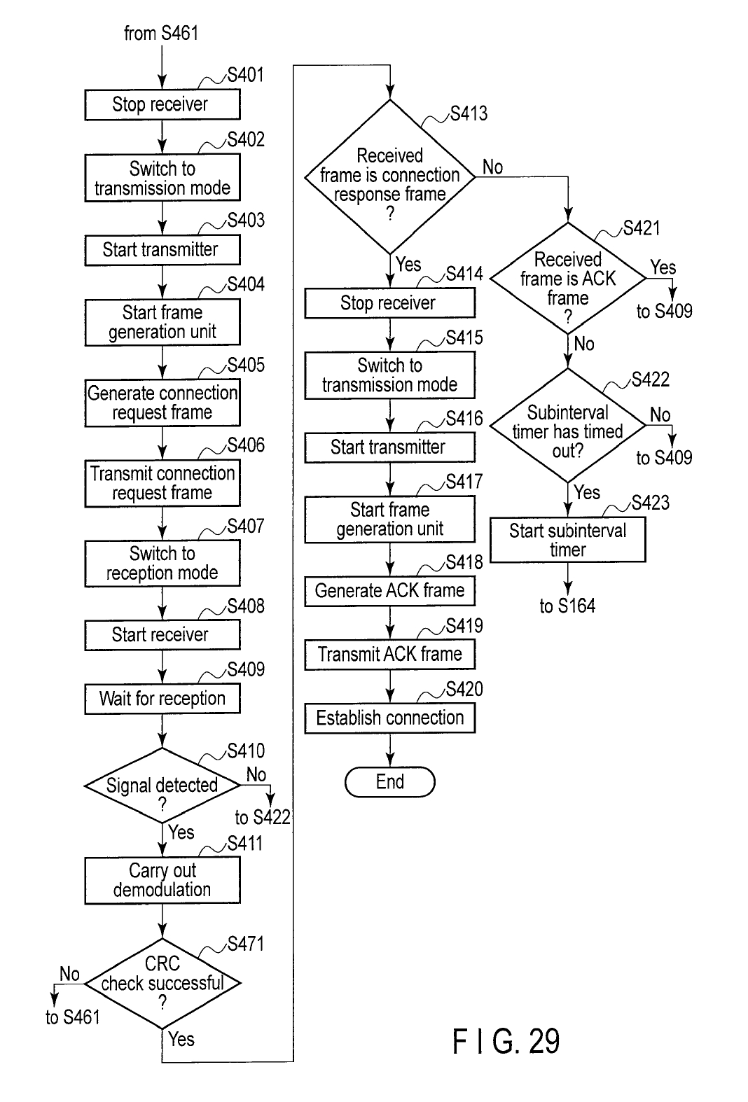

An example of operation of the wireless communication apparatus according to the present embodiment will be described below with reference to FIG. 9, FIG. 12, FIG. 15, FIG. 17, FIG. 23, FIG. 27, FIG. 28, and FIG. 29. The operation of the wireless communication apparatus according to the present embodiment partly overlaps the operation illustrated in FIG. 9, FIG. 12, FIG. 15, FIG. 17, FIG. 23, FIG. 27, and FIG. 28 (that is, the operation of the wireless communication apparatus in FIG. 26). FIG. 29 illustrates a portion of the operation of the wireless communication apparatus according to the present embodiment which is different from the corresponding portion of the operation illustrated in FIG. 9, FIG. 12, FIG. 15, FIG. 17, FIG. 23, FIG. 27, and FIG. 28. Steps S401, . . . , S410, 5413, . . . , and 5423 in FIG. 29 are the same as the corresponding steps in FIG. 23. Furthermore, step S411 is different from the corresponding step in FIG. 23 in the steps to which step S411 branches but is the same as the corresponding step in FIG. 23 in the contents of processing.

After step S461 in FIG. 28, the processing proceeds to step S401 in FIG. 29 instead of step S461 in FIG. 28. After step S411, the processing proceeds to step S471. In step S471, if a CRC check is successful, the processing proceeds to step S413. Otherwise the processing returns to step S461 in FIG. 28.

An example of operation of the wireless communication apparatus according to the present embodiment will be described below with reference to FIG. 52.

FIG. 52 illustrates an operation performed by the wireless communication apparatus according to the present embodiment if a reception error occurs while the wireless communication apparatus is waiting for reception using the frequency channel 2. As shown in FIG. 52, during a subinterval 5201, the wireless communication apparatus uses the frequency channel 1 to wait for reception during an active-state period 5203, and after switching of the frequency channel, uses the frequency channel 2 to wait for reception during an active-state period 5204. If a reception error occurs during the active-state period 5204, the channel used by the wireless unit 12, the transmitter 13, and the receiver 15 is fixed to the frequency channel 2. When a SIFS period 5205 elapses from the occurrence of the reception error, the wireless communication apparatus uses the frequency channel 2 to transmit a connection request frame 5206. When a SIFS period 5207 elapses from the transmission of the connection request frame 5206, the wireless communication apparatus uses the frequency channel 2 to wait to receive a response signal from the peer wireless communication apparatus (5208).

As described above, when an error occurs in reception of a connection request frame, the wireless communication apparatus according to the fourteenth embodiment fixes the channel used and generates and transmits a connection request frame. Thus, the present wireless communication apparatus allows a connection to be easily established in a short time.

### Fifteenth Embodiment

In the above-described embodiments, various operations of the wireless communication apparatus during a subinterval measured during an interval have been described. A wireless communication apparatus according to a fifteenth embodiment utilizes an interval equal to an integral multiple of a subinterval (an interval that is twice, three times, . . . as long as a subinterval).

FIG. 30 illustrates an interval 501 that is four times as long as a subinterval. That is, within the interval 501, up to four subintervals 502, 503, 504, and 505 can be measured.

The wireless communication apparatuses according to the above-described embodiments can be roughly classified into those which transmit connection request frames and those which receive connection response frames. However, a single wireless communication apparatus may be expected to switch the operation thereof in a time division manner. That is, a wireless communication apparatus that transmits a connection request frame during one subinterval may wait to receive a connection request frame during another subinterval. Even when asynchronous wireless communication apparatuses each configured to switch the operation thereof attempt to connect to each other, the wireless communication apparatuses are easily connected together if one interval includes a plurality of subintervals.

As described above, the wireless communication apparatus according to the fifteenth embodiment utilizes an interval equal to an integral multiple of a subinterval (an interval that is twice, three times, . . . as long as a subinterval). Thus, the wireless communication apparatus can be easily connected to the peer wireless communication apparatus.

### Sixteenth Embodiment

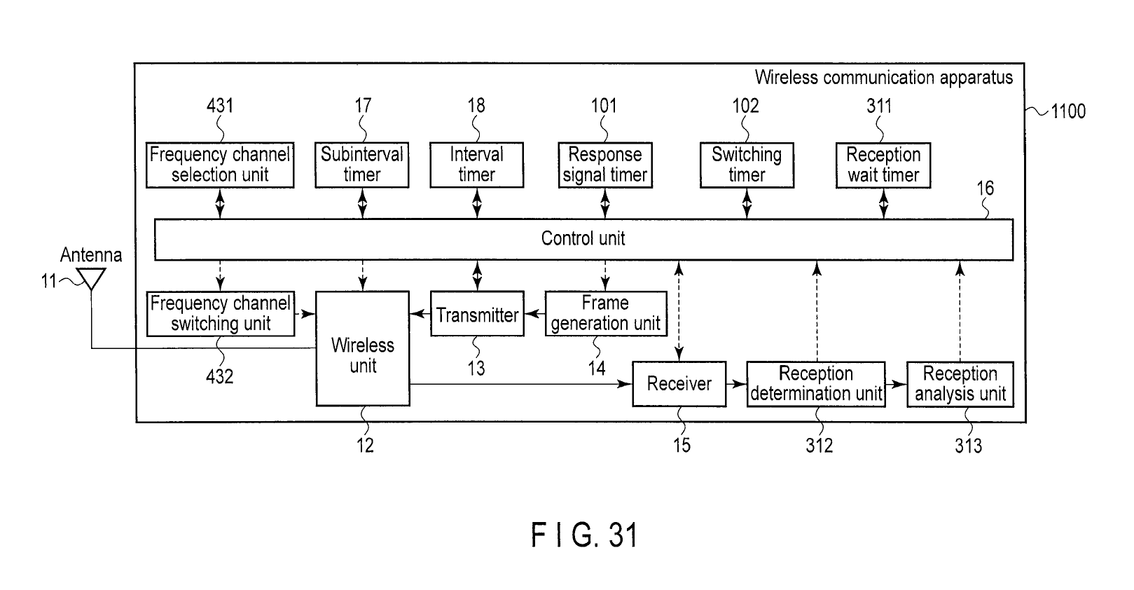

FIG. 31 schematically shows a wireless communication apparatus 1100 according to a sixteenth embodiment. The wireless communication apparatus 1100 corresponds to a configuration in which the antenna 11 is contained in the wireless communication apparatus in FIG. 24. When the antenna is contained in the wireless communication apparatus as described above, the wireless communication apparatus can be implemented as one apparatus including even an antenna. Thus, the footprint of the wireless communication apparatus can be reduced. Furthermore, the wireless communication apparatus 1100 uses the antenna 11 both for transmission processing and for reception processing. When the antenna 11 is utilized both for transmission processing and for reception processing, the wireless communication apparatus can be made smaller than when separate antennas are utilized for transmission processing and for reception processing, respectively.

### Seventeenth Embodiment

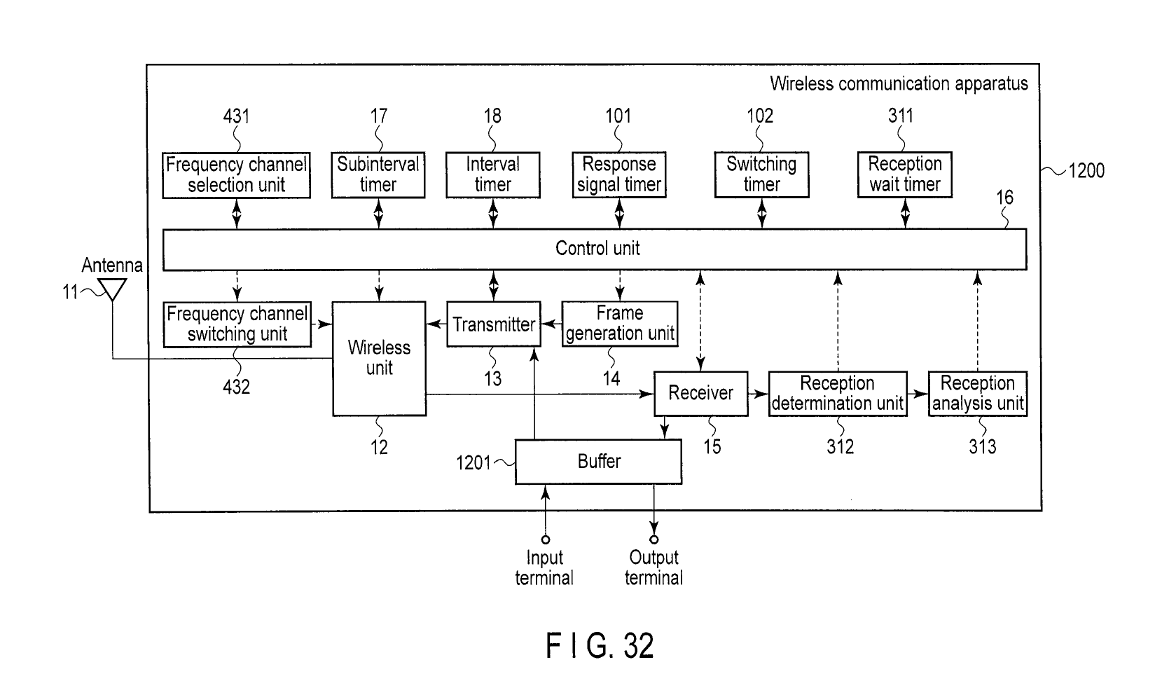

FIG. 32 schematically shows a wireless communication apparatus 1200 according to a seventeenth embodiment. The wireless communication apparatus 1200 comprises not only the components of the wireless communication apparatus in FIG. 24 but also a buffer 1201. The buffer 1201 is connected to each of the transmitter 13 and the receiver 15. When the wireless communication apparatus includes the buffer as described above, transmission and reception data can be held in the buffer. This enables a retransmission process and an external output process to be easily carried out.

### Eighteenth Embodiment

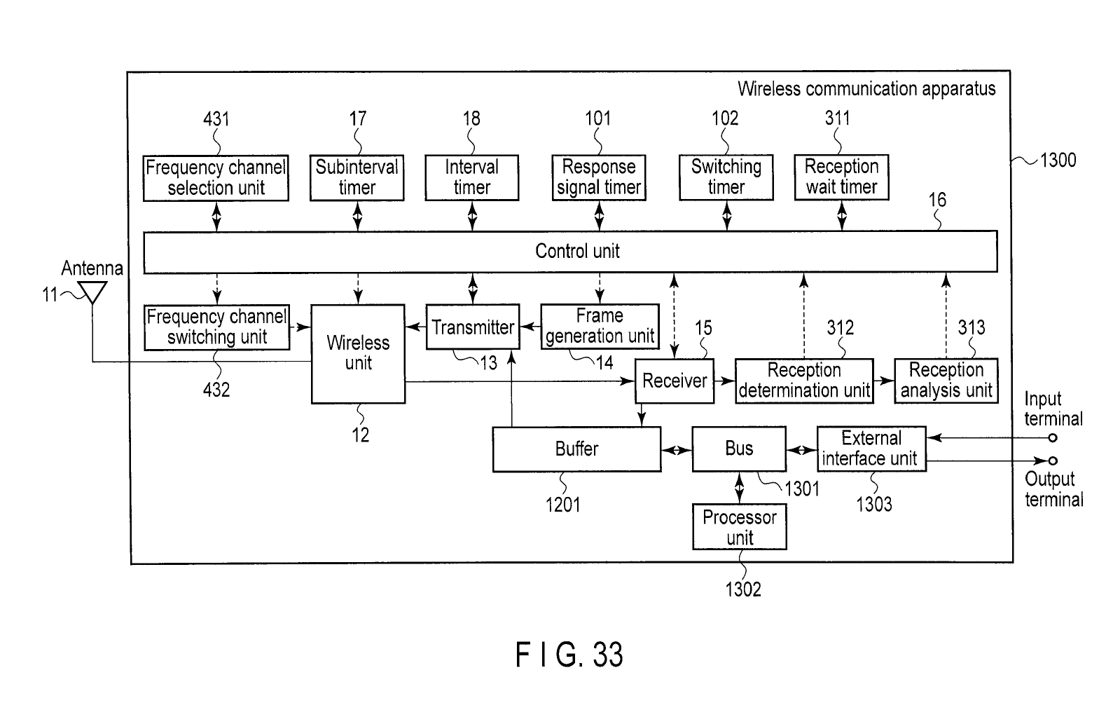

FIG. 33 schematically shows a wireless communication apparatus 1300 according to an eighteenth embodiment. The wireless communication apparatus 1300 comprises not only the components of the wireless communication apparatus 1200 in FIG. 32 but also a bus 1301, a processor unit 1302, and an external interface unit 1303. The processor unit 1302 and the external interface unit 1303 are connected to the buffer 1201 via the bus 1301. Firmware operates in the processor unit 1302. When the wireless communication apparatus includes the firmware as described above, the functions of the wireless communication apparatus can be easily modified by rewriting the firmware.

### Nineteenth Embodiment

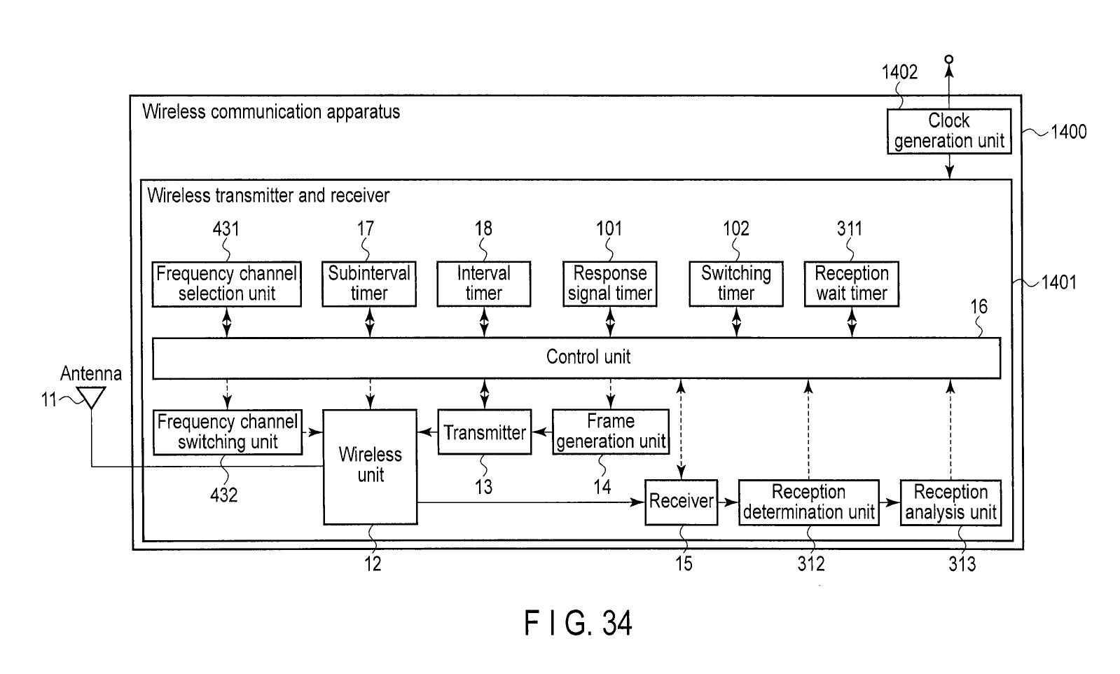

FIG. 34 schematically shows a wireless communication apparatus 1400 according to a nineteenth embodiment. The wireless communication apparatus 1400 comprises not only a wireless transmitter and receiver 1401 corresponding to the components of the wireless communication apparatus in FIG. 24 but also a clock generation unit 1402. The clock generation unit 1402 is connected to the wireless transmitter and receiver 1401 to output a generated clock to the wireless transmitter and receiver 1401. Moreover, the clock generated by the clock generation unit 1402 is also output to the exterior via an output terminal. When the clock generated inside the wireless communication apparatus is output to the exterior as described above to operate a host side in accordance with the clock output to the exterior, the wireless communication apparatus can be operated in synchronism with the host side.

### Twentieth Embodiment

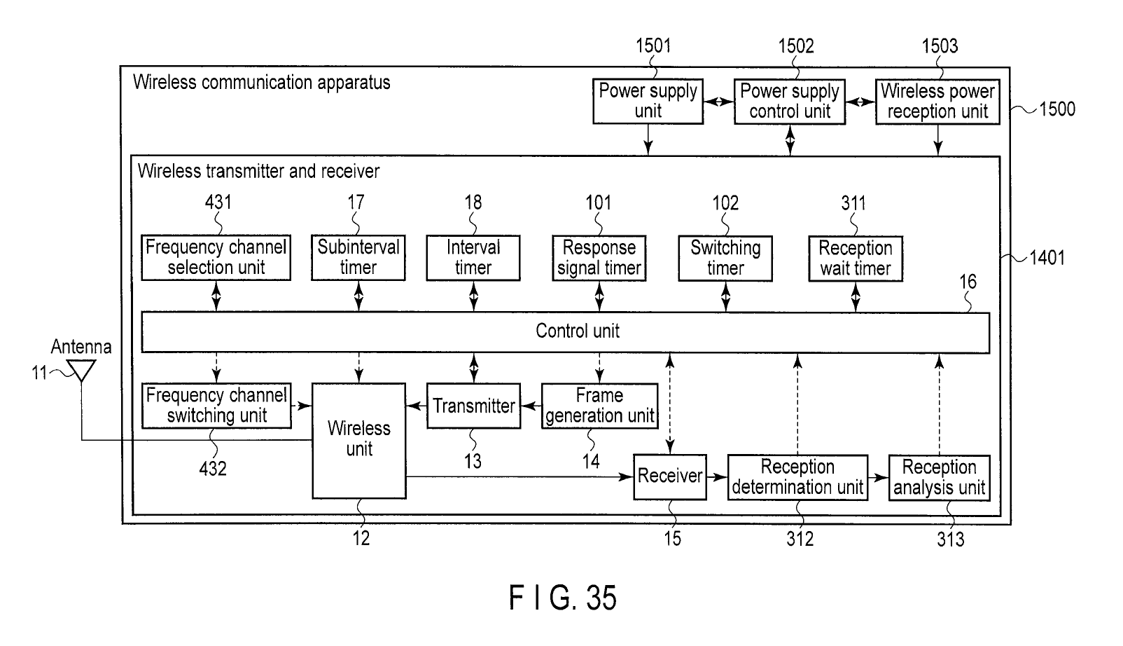

FIG. 35 schematically shows a wireless communication apparatus 1500 according to a twentieth embodiment. The wireless communication apparatus 1500 comprises not only the wireless transmitter and receiver 1401 corresponding to the components of the wireless communication apparatus in FIG. 24 but also a power supply unit 1501, a power supply control unit 1502, and a wireless power receiver 1503. The power supply unit 1501, the power supply control unit 1502, and the wireless power receiver 1503 are each connected to the wireless transmitter and receiver 1401. When the wireless communication apparatus comprises the power supply as described above, power consumption involved in power supply control can be reduced.

### Twenty-first Embodiment

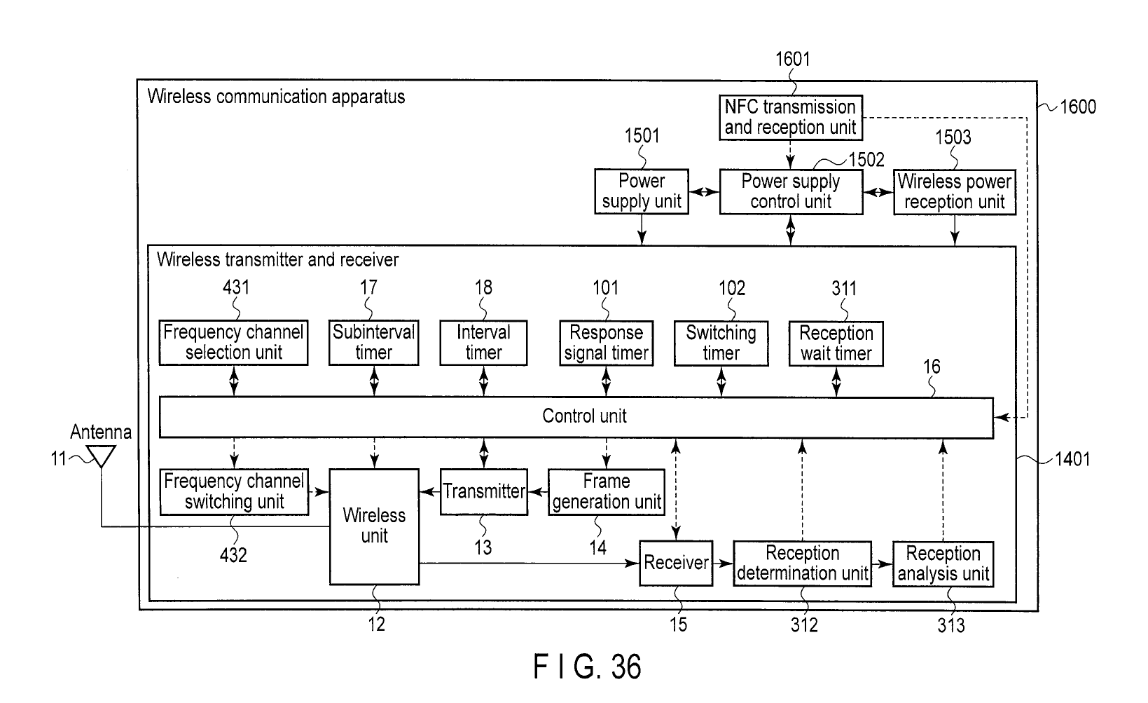

FIG. 36 schematically shows a wireless communication apparatus 1600 according to a twenty-first embodiment. The wireless communication apparatus 1600 comprises not only the components of the wireless communication apparatus 1500 in FIG. 35 but also an NFC (Near Field Communications) transmitter and receiver 1601. The NFC transmitter and receiver 1601 is connected to the power supply control unit 1502 and the control unit 16. When the wireless communication apparatus comprises the NFC transmitter and receiver as described above, an authentication process can be easily carried out. Moreover, when the power supply is controlled by using a predetermined operation of the NFC transmitter and receiver as a trigger, the power consumption during a wait for reception can be reduced.

### Twenty-second Embodiment

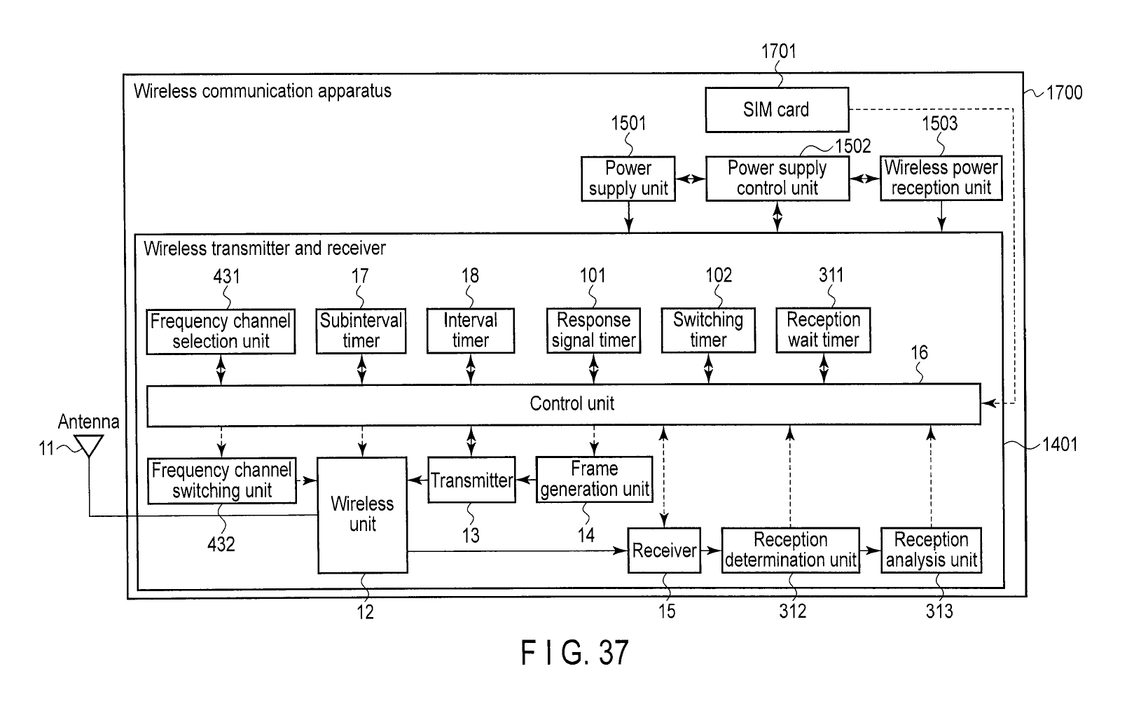

FIG. 37 schematically shows a wireless communication apparatus 1700 according to a twenty-second embodiment. The wireless communication apparatus 1700 comprises not only the components of the wireless communication apparatus 1500 in FIG. 35 but also a SIM (subscriber identity module) card 1701. The SIM card 1701 is connected to the control unit 16. When the wireless communication apparatus comprises the SIM card as described above, the authentication process can be easily carried out.

### Twenty-third Embodiment

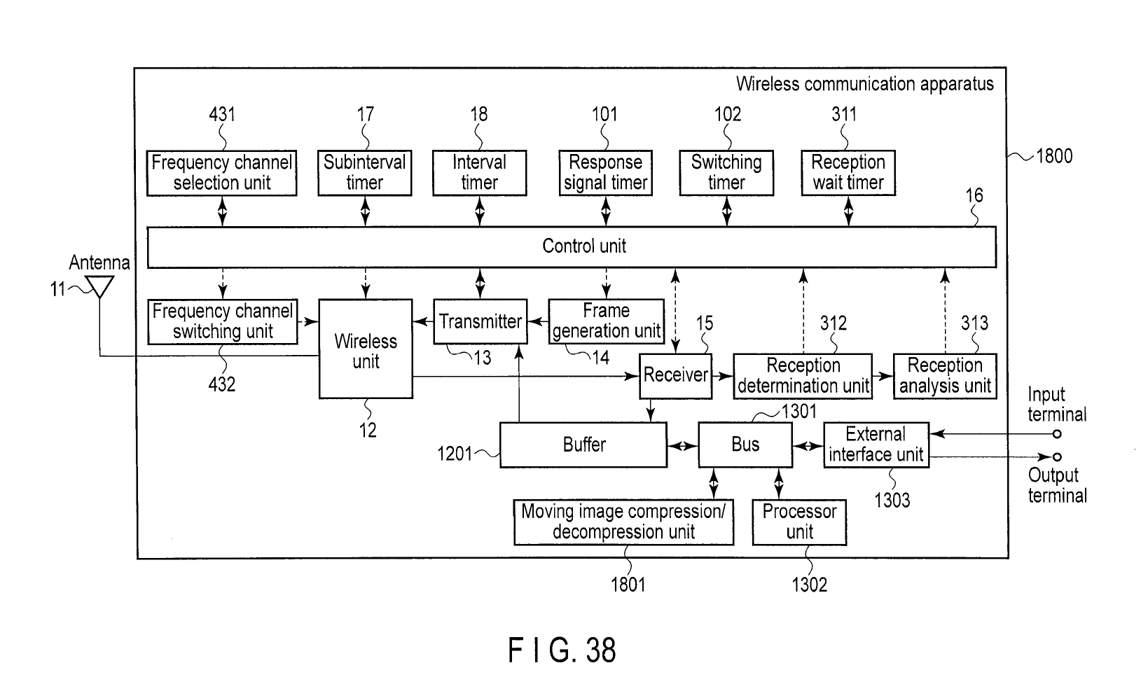

FIG. 38 schematically shows a wireless communication apparatus 1800 according to a twenty-third embodiment. The wireless communication apparatus 1800 comprises not only the components of the wireless communication apparatus 1300 in FIG. 33 but also a moving image compression/decompression unit 1801. The moving image compression/decompression unit 1801 is connected to the bus 1301. The wireless communication apparatus comprising the moving image compression/decompression unit as described above can easily transmit compressed moving images and decompress the received compressed moving images.

### Twenty-fourth Embodiment

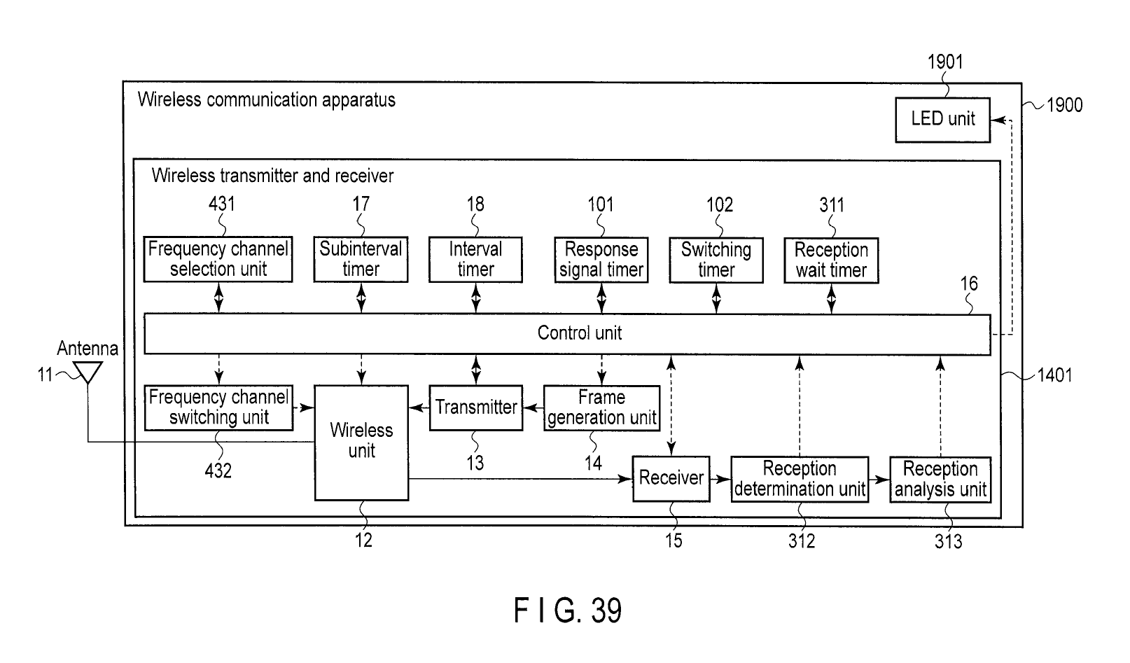

FIG. 39 schematically shows a wireless communication apparatus 1900 according to a twenty-fourth embodiment. The wireless communication apparatus 1900 comprises not only the wireless transmitter and receiver 1401 corresponding to the configuration of the wireless communication apparatus in FIG. 24 but also an LED unit 1901. The LED unit 1901 is connected to the control unit 16. When the wireless communication apparatus comprises the LED as described above, a user can be easily notified of the operational status of the wireless communication apparatus.

### Twenty-fifth Embodiment

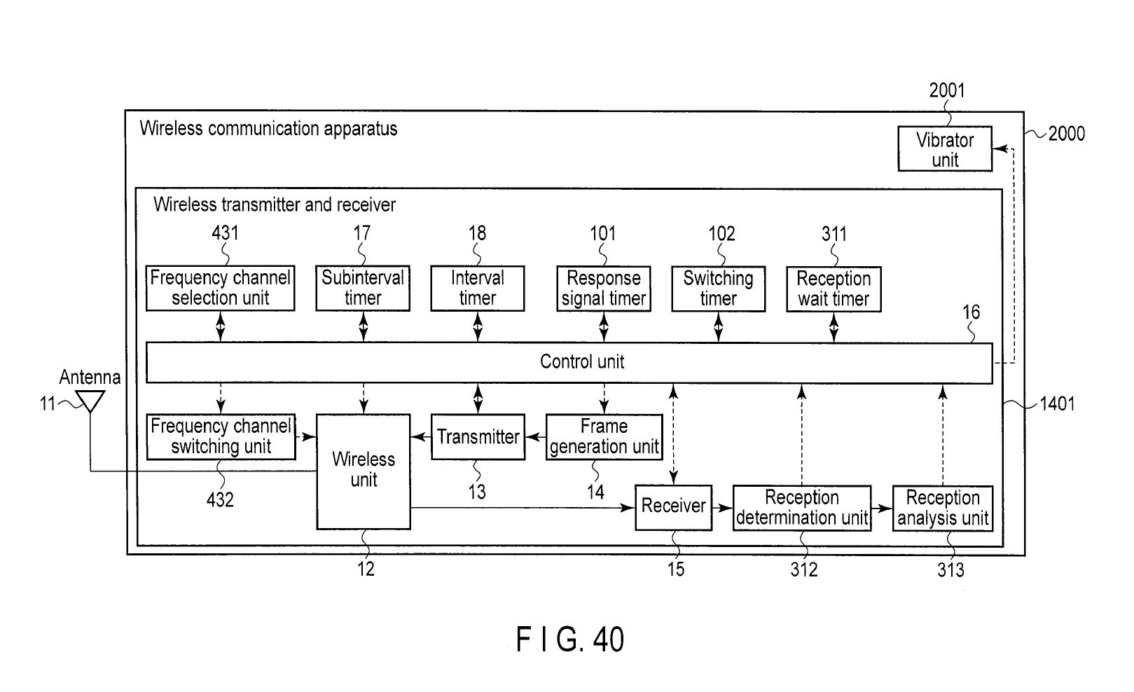

FIG. 40 schematically shows a wireless communication apparatus 2000 according to a twenty-fifth embodiment. The wireless communication apparatus 2000 comprises not only the wireless transmitter and receiver 1401 corresponding to the configuration of the wireless communication apparatus in FIG. 24 but also a vibrator unit 2001. The vibrator unit 2001 is connected to the control unit 16. When the wireless communication apparatus comprises the vibrator as described above, the user can be easily notified of the operational status of the wireless communication apparatus.

### Twenty-sixth Embodiment

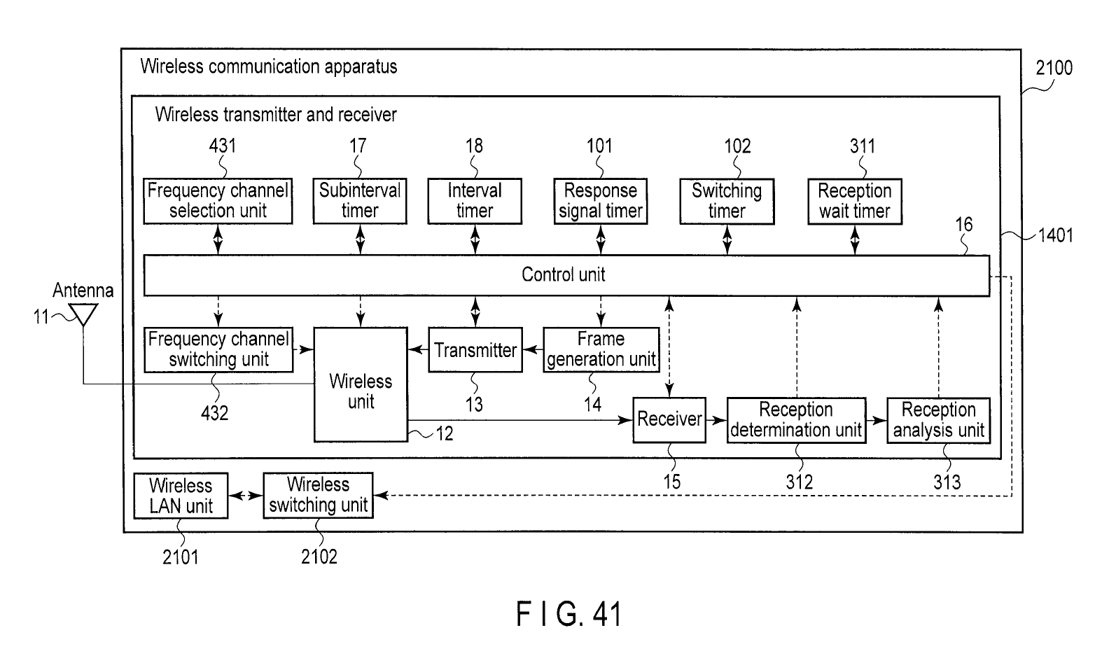

FIG. 41 schematically shows a wireless communication apparatus 2100 according to a twenty-sixth embodiment. The wireless communication apparatus 2100 comprises not only the wireless transmitter and receiver 1401 corresponding to the configuration of the wireless communication apparatus in FIG. 24 but also a wireless LAN unit 2101 and a wireless switching unit 2102. The wireless switching unit 2102 is connected to the control unit 16 and the wireless LAN unit 2101. The wireless communication apparatus comprising the wireless LAN unit as described above can switch between wireless LAN communication and communication based on the wireless transmitter and receiver 1401, depending on the situation.

### Twenty-seventh Embodiment

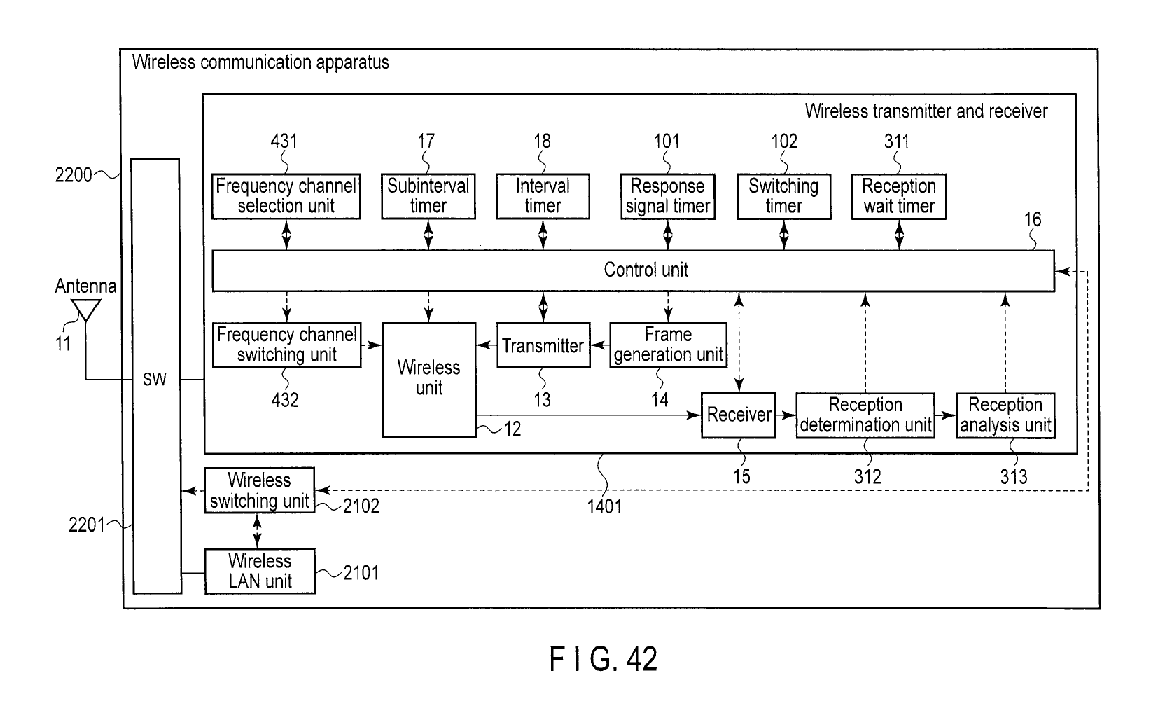

FIG. 42 schematically shows a wireless communication apparatus 2200 according to a twenty-seventh embodiment. The wireless communication apparatus 2200 comprises not only the components of the wireless communication apparatus 2100 in FIG. 41 but also a switch (SW) 2201. The wireless communication apparatus comprising the switch as described above can switch between the wireless LAN communication and the communication based on the wireless transmitter and receiver 1401, depending on the situation, sharing a single antenna for both communications.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor disk, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first timer configured to periodically measure a first time interval;
a generation unit configured to generate a connection request frame;
a transmitter configured to transmit the connection request frame;
a receiver configured to receive a response signal provided in response to the connection request frame; and
a control unit configured to control the transmitter and the receiver in such a manner that iterative attempts are made to carry out a transmission of the connection request frame and a wait for reception of the response signal during the first time interval measured by the first timer.

2. The apparatus according to claim 1, wherein the first time interval includes an iteration of unit periods of time with a first period of time when the connection request frame is transmitted, a second period of time when the receiver remains stopped after the first period of time, a third period of time when the receiver is kept active and waits for the response signal, after the second period of time, and a fourth period of time when the receiver remains stopped after the third period of time.

3. A wireless communication apparatus comprising:
a first timer configured to periodically measure a first time interval;
a second timer configured to measure a second time interval at least once during the first time interval measured by the first timer, the second time interval being shorter than the first time interval;
a receiver configured to receive a first connection request frame;
a generation unit configured to generate a response signal provided in response to the first connection request frame;
a transmitter configured to transmit the response signal; and
a control unit configured to control the receiver in such a manner that the receiver is active during the second time interval measured by the second timer.

4. The apparatus according to claim 3, further comprising a determination unit configured to determine whether or not a reception error has occurred, and
wherein the control unit continues to keep the receiver active even after the second timer finishes measuring the second time interval when the determination unit determines that the reception error has occurred.

5. The apparatus according to claim 3, wherein the second time interval is equal to a sum of a period of time when a peer wireless communication apparatus transmits the first connection request frame and a period of time when the peer wireless communication apparatus waits to receive the response signal.

6. The apparatus according to claim 3, further comprising an analysis unit configured to analyze a type of a signal correctly received by the receiver, and
wherein when the type of the signal correctly received by the receiver matches the first connection request frame, the generation unit generates one of a connection response frame and an acknowledge (ACK) frame, and
the transmitter transmits the frame generated by the generation unit.

7. The apparatus according to claim 3, further comprising a determination unit configured to determine whether or not a reception error has occurred, and
wherein the generation unit generates a second connection request frame when the determination unit determines that the reception error has occurred, and
the transmitter transmits the second connection request frame.

8. The apparatus according to claim 1, further comprising a selector unit configured to select one of a plurality of frequency channels; and
a switch unit configured to switch a channel used by the transmitter and the receiver in accordance with the frequency channel selected by the selector unit.

9. The apparatus according to claim 3, further comprising a switch unit configured to switch the channel used by the transmitter and the receiver to one of the plurality of frequency channels, and
wherein the second timer measures the second time interval a plurality of times during the first time interval measured by the first timer, and
the switch unit switches the channel used by the transmitter and the receiver to a different frequency channel every time the second timer measures the second time interval.

10. The apparatus according to claim 4, further comprising a switch unit configured to switch the channel used by the transmitter and the receiver to one of the plurality of frequency channels, and
wherein when the determination unit determines that the reception error has occurred, the switch unit fixes the channel used by the transmitter and the receiver to a channel on which the reception error is determined to have occurred.

11. The apparatus according to claim 3, further comprising:
a determination unit configured to determine whether or not a reception error has occurred;
a switch unit configured to switch the channel used by the transmitter and the receiver to one of the plurality of frequency channels, and
wherein when the determination unit determines that the reception error has occurred, the switch unit fixes the channel used by the transmitter and the receiver to a channel on which the reception error is determined to have occurred,
when the determination unit determines that the reception error has occurred, the generation unit generates a second connection request frame, and
the transmitter transmits the second connection request frame.

12. The apparatus according to claim 1, further comprising a third timer configured to measure a third time interval which is equal to an integral multiple of the first time interval and which is longer than the first time interval, and
wherein the first timer measures the first time interval at least once during the third time interval measured by the third timer.
